(19) United States
(12) Patent Application Publication
(10) Pub. No.: US 2025/0322314 A1
(43) Pub. Date: Oct. 16, 2025

(54) CHUNKING, POOLING, AND LABEL ATTENTION TECHNIQUES FOR GENERATING EXPLAINABLE PREDICTIONS

(71) Applicant: Optum, Inc., Minnetonka, MN (US)

(72) Inventors: Jun Han, Union City, NJ (US); Joel David Stremmel, Iowa City, IA (US); Sanjit Singh Batra, Redwood City, CA (US); Robert Elliott Tillman, Long Island City, NY (US)

(21) Appl. No.: 18/632,818

(22) Filed: Apr. 11, 2024

(51) Int. Cl. G06N 20/20

(52) U.S. Cl. CPC G06N 20/20

(57) ABSTRACT

Embodiments of the present disclosure provide systems and methods for generating explainable predictions. One method may include generating a plurality of overlapping data chunks from an input data object, generating, using a machine learning class-agnostic model, a plurality of intermediate feature representations respectively corresponding to the plurality of overlapping data chunks, generating, using a machine learning class-specific model, a plurality of chunk-based classification probabilities from the plurality of intermediate representations that correspond to a particular prediction class, generating, using the plurality of chunk-based classification probabilities, a plurality of class scores for the plurality of overlapping data chunks, and, providing, by the one or more processors, a classification output that is based on the plurality of class scores and comprises a class prediction for the input data object and an overlapping data chunk from the plurality of overlapping data chunks that corresponds to the class prediction.

### BACKGROUND

Various embodiments of the present disclosure address technical challenges related to machine learning. In a variety of data-intensive applications, various types of source documents may contain unstructured or unclassified information. For example, in a healthcare context, a physician's note may include a natural language summary of an appointment with a patient. As another illustrative example, a call transcript between a customer service agent and a customer may include a natural language summary describing various customer inquiries and corresponding responses provided by the customer service agent. However, existing methods for classifying various types of information included in such source documents are labor intensive, inefficient, and prone to errors. For example, in some contexts, source documents may be manually evaluated to determine relevant information and/or classifications for various types of information. However, such manual classification tasks may present various inefficiencies and inaccuracies. In some other examples, machine learning may be applied to classify information in source documents, however, such techniques also present various classification inaccuracies, among other drawbacks, such as the introduction of unintended biases and a lack of transparency regarding how various classifications are generated. Various embodiments of the present disclosure make important contributions to various existing machine learning approaches by addressing these technical challenges.

### BRIEF SUMMARY

Various embodiments of the present disclosure provide systems and methods for improving machine learning and, more specifically, improving the explainability of machine learning classification techniques using explainable predictions. For example, techniques of the present disclosure involve the generation of a classification output from an input data object. The classification output may include a class prediction for the input data object and context information for the class prediction, such as a portion of the input data object that the class prediction was derived from. To do this, a multi-class ensemble classification model may be utilized. For example, multiple types of machine learning models may be utilized in combination to generate a classification output. By combining multiple types of machine learning models as described herein, the accuracy of various classification tasks may be improved when compared to conventional techniques. Moreover, providing a portion of an input data object that a class prediction was derived from may improve classification trustworthiness when compared to conventional techniques.

In some embodiments, a method includes generating, by one or more processors, a plurality of overlapping data chunks from an input data object; generating, by the one or more processors and using a machine learning class-agnostic model, a plurality of intermediate feature representations respectively corresponding to the plurality of overlapping data chunks; generating, by the one or more processors and using a machine learning class-specific model, a plurality of chunk-based classification probabilities from the plurality of intermediate representations that correspond to a particular prediction class within a multi-class prediction domain; generating, by the one or more processors and using the plurality of chunk-based classification probabilities, a plurality of class scores for the plurality of overlapping data chunks with respect to the particular prediction class; and providing, by the one or more processors, a classification output that is (i) based on the plurality of class scores and (ii) comprises (a) a class prediction for the input data object and (b) an overlapping data chunk from the plurality of overlapping data chunks that corresponds to the class prediction.

In some embodiments, a computing system includes memory and one or more processors communicatively coupled to the memory, the one or more processors configured to: generate a plurality of overlapping data chunks from an input data object; generate, using a machine learning class-agnostic model, a plurality of intermediate feature representations respectively corresponding to the plurality of overlapping data chunks; generate, using a machine learning class-specific model, a plurality of chunk-based classification probabilities from the plurality of intermediate representations that correspond to a particular prediction class within a multi-class prediction domain; generate, using the plurality of chunk-based classification probabilities, a plurality of class scores for the plurality of overlapping data chunks with respect to the particular prediction class; and provide a classification output that is (i) based on the plurality of class scores and (ii) comprises (a) a class prediction for the input data object and (b) an overlapping data chunk from the plurality of overlapping data chunks that corresponds to the class prediction.

In some embodiments, one or more non-transitory computer-readable storage media include instructions that, when executed by one or more processors, cause the one or more processors to: generate a plurality of overlapping data chunks from an input data object; generate, using a machine learning class-agnostic model, a plurality of intermediate feature representations respectively corresponding to the plurality of overlapping data chunks; generate, using a machine learning class-specific model, a plurality of chunk-based classification probabilities from the plurality of intermediate representations that correspond to a particular prediction class within a multi-class prediction domain; generate, using the plurality of chunk-based classification probabilities, a plurality of class scores for the plurality of overlapping data chunks with respect to the particular prediction class; and provide a classification output that is (i) based on the plurality of class scores and (ii) comprises (a) a class prediction for the input data object and (b) an overlapping data chunk from the plurality of overlapping data chunks that corresponds to the class prediction.

### BRIEF DESCRIPTION OF THE DRAWINGS

FIG. 1 illustrates an example overview of an architecture in accordance with one or more embodiments of the present disclosure.

FIG. 2A is an example computing entity in accordance with one or more embodiments of the present disclosure.

FIG. 2B is an example client computing entity in accordance with some embodiments of the present disclosure.

FIG. 3 is a dataflow diagram showing example data structures and modules for generating explainable predictions in accordance with some embodiments discussed herein.

FIG. 4 is a dataflow diagram showing example data structures and modules for generating explainable predictions in accordance with some embodiments discussed herein.

FIG. 5 is a dataflow diagram showing example data structures and modules for generating explainable predictions in accordance with some embodiments discussed herein.

FIG. 6 is a flowchart diagram of an example process for generating explainable predictions in accordance with some embodiments discussed herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. COMPUTER PROGRAM PRODUCTS, METHODS, AND COMPUTING ENTITIES

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

A non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

A volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. EXAMPLE FRAMEWORK

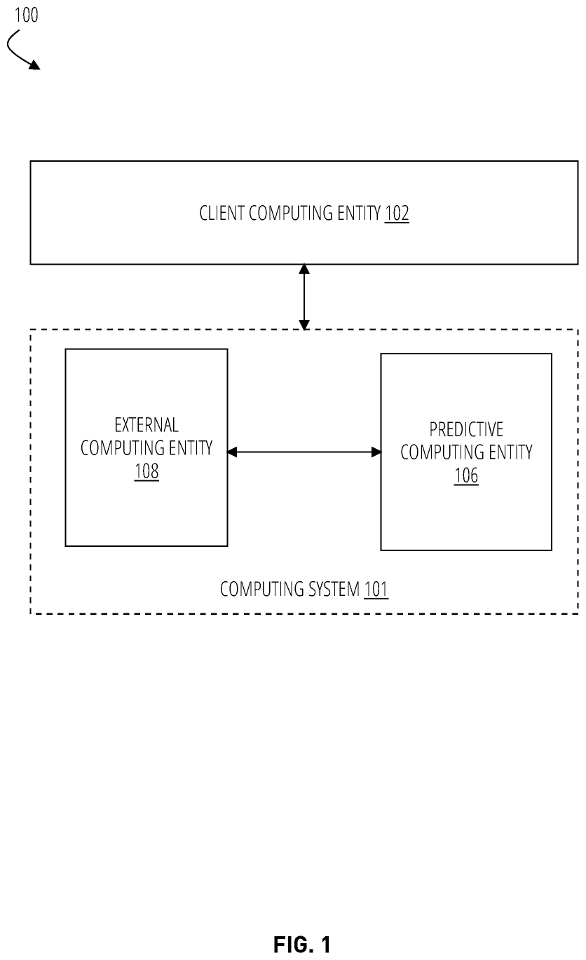

FIG. 1 provides an example overview of an architecture 100 in accordance with some embodiments of the present disclosure. The architecture 100 includes a computing system 101 configured to generate a plurality of predictive measures (e.g., in response to request from client computing entities 102), process the predictive measures to generate impact predictions for a plurality of prediction-based actions, and facilitate improved user interfaces (and/or information for the user interface) based on the impact predictions for the client computing entities 102. The example architecture 100 may be used in a plurality of domains and not limited to any specific application as disclosed herewith. The plurality of domains may include banking, healthcare, industrial, manufacturing, education, retail, to name a few.

In accordance with various embodiments of the present disclosure, a predictive machine learning pipeline may include a sequence of models that may be trained to generate one or more of the medical code predictions described herein. By doing so, one or more medical code predictions may be generated and aggregated from a plurality of overlapping data chunks. By doing so, the techniques of the present disclosure may lead to improved accuracy and reliability for medical code predictions.

In some embodiments, the computing system 101 may communicate with at least one of the client computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may include a predictive computing entity 106 and one or more external computing entities 108. The predictive computing entity 106 and/or one or more external computing entities 108 may be individually and/or collectively configured to receive requests from client computing entities 102, process the requests to generate predictions and/or provide healthcare data based on the generated predictions, and provide the generated predictions to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data analysis and/or training tasks. The storage subsystem may include one or more storage units, such as multiple distributed storage units that are connected through a computer network. Each storage unit in the respective computing entities may store at least one of one or more data assets and/or one or more data about the computed properties of one or more data assets. Moreover, each storage unit in the storage systems may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In some embodiments, the predictive computing entity 106 and/or one or more external computing entities 108 are communicatively coupled using one or more wired and/or wireless communication techniques. The respective computing entities may be specially configured to perform one or more steps/operations of one or more techniques described herein. By way of example, the predictive computing entity 106 may be configured to train, implement, use, update, and evaluate machine learning models in accordance with one or more training and/or prediction operations of the present disclosure. In some examples, the external computing entities 108 may be configured to train, implement, use, update, and evaluate machine learning models in accordance with one or more training and/or prediction operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., machine learning techniques) described herein. The external computing entities 108, for example, may include and/or be associated with one or more entities that may be configured to receive, transmit, store, manage, and/or facilitate datasets, such as a dataset including a plurality of source documents (e.g., input data objects), metric requirements, historical interaction data objects, predictive entity data, evaluation entity data, entity group data, and/or the like. The external computing entities 108, for example, may include data sources that may provide such datasets, and/or the like to the predictive computing entity 106 which may leverage the datasets to perform one or more steps/operations of the present disclosure, as described herein. In some examples, the datasets may include an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for a prediction domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more prediction steps/operations of the present disclosure. In some examples, feedback (e.g., evaluation data, ground truth data, etc.) from the use the of the machine learning model may be recorded by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Computing Entity

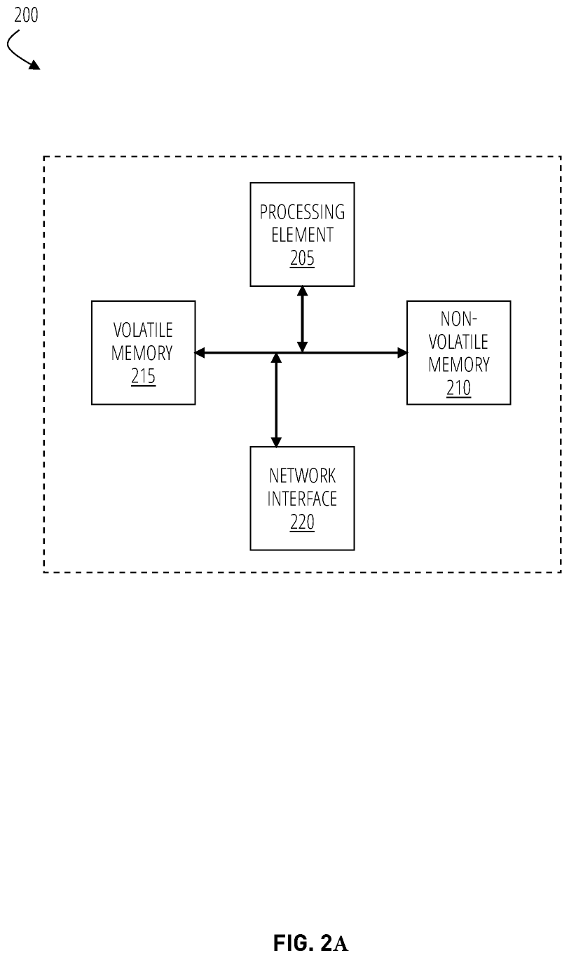

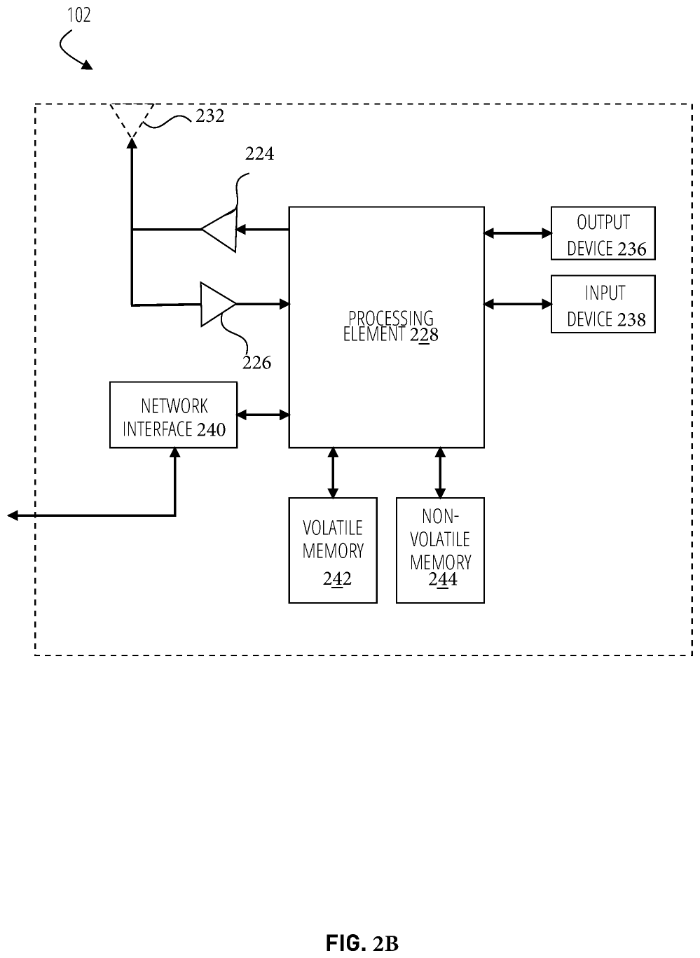

FIG. 2A provides an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106, etc.) may train and use one or more machine learning models described herein. In other embodiments, a first computing entity (e.g., predictive computing entity 106, etc.) may use one or more machine learning models that may be trained by a second computing entity (e.g., external computing entity 108) communicatively coupled to the first computing entity. The second computing entity, for example, may train one or more of the machine learning model(s) described herein, and subsequently provide the trained machine learning model(s) (e.g., optimized weights, code sets, etc.) to the first computing entity over a network.

As shown in FIG. 2A, in some embodiments, the computing entity 200 may include, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further include, or be in communication with, non-volatile media (also referred to as non-volatile storage, memory, memory storage, memory circuitry, and/or similar terms used herein interchangeably). In some embodiments, the non-volatile media may include one or more non-volatile memory 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile media may store databases, database instances, database management systems, data, applications, programs, program modules, scripts, code (e.g., source code, object code, byte code, compiled code, interpreted code, machine code, etc.) that embodies one or more machine learning models or other computer functions described herein, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In some embodiments, the computing entity 200 may further include, or be in communication with, volatile media (also referred to as volatile storage, memory, memory storage, memory circuitry, and/or similar terms used herein interchangeably). In some embodiments, the volatile media may also include one or more volatile memory 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, code (source code, object code, byte code, compiled code, interpreted code, machine code) that embodies one or more machine learning models or other computer functions described herein, executable instructions, and/or the like being executed by, for example, the processing element 205. Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 with the assistance of the processing element 205 and operating system.

As indicated, in some embodiments, the computing entity 200 may also include one or more network interfaces 220 for communicating with various computing entities (e.g., the client computing entity 102, external computing entities, etc.), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may include, or be in communication with, one or more input elements, such as a keyboard input, a mouse input, a touch screen/display input, motion input, movement input, audio input, pointing device input, joystick input, keypad input, and/or the like. The computing entity 200 may also include, or be in communication with, one or more output elements (not shown), such as audio output, video output, screen/display output, motion output, movement output, and/or the like.

### B. Example Client Computing Entity

FIG. 2B provides an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 2B, the client computing entity 102 may include an antenna 232, a transmitter 224 (e.g., radio), a receiver 246 (e.g., radio), and a processing element 228 (e.g., CPLDs, microprocessors, multi-core processors, coprocessing entities, ASIPs, microcontrollers, and/or controllers) that provides signals to and receives signals from the transmitter 224 and receiver 226, correspondingly.

The signals provided to and received from the transmitter 224 and the receiver 226, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the computing entity 200. In some embodiments, the client computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the computing entity 200 via a network interface 240.

Via these communication standards and protocols, the client computing entity 102 may communicate with various other entities using mechanisms such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 may also download code, changes, add-ons, and updates, for instance, to its firmware, software (e.g., including executable instructions, applications, program modules), and operating system.

According to some embodiments, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In some embodiments, the location module may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the DecimalDegrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface (that may include an output device 236 (e.g., display, speaker, tactile instrument, etc.) coupled to a processing element 228) and/or a user input interface (coupled to a processing element 228). For example, the user interface may be a user application, browser, user interface, and/or similar words used herein interchangeably executing on and/or accessible via the client computing entity 102 to interact with and/or cause display of information/data from the computing entity 200, as described herein. The user input interface may comprise any of a plurality of input devices 238 (or interfaces) allowing the client computing entity 102 to receive code and/or data, such as a keypad (hard or soft), a touch display, voice/speech or motion interfaces, or other input device. In some embodiments including a keypad, the keypad may include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface may be used, for example, to activate or deactivate certain functions, such as screen savers and/or sleep modes.

The client computing entity 102 may also include volatile memory 242 and/or non-volatile memory 244, which may be embedded and/or may be removable. For example, the non-volatile memory 244 may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory 242 may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile memory may store databases, database instances, database management systems, data, applications, programs, program modules, scripts, code (source code, object code, byte code, compiled code, interpreted code, machine code, etc.) that embodies one or more machine learning models or other computer functions described herein, executable instructions, and/or the like to implement the functions of the client computing entity 102. As indicated, this may include a user application that is resident on the client computing entity 102 or accessible through a browser or other user interface for communicating with the computing entity 200 and/or various other computing entities.

In another embodiment, the client computing entity 102 may include one or more components or functionalities that are the same or similar to those of the computing entity 200, as described in greater detail above. In one such embodiment, the client computing entity 102 downloads, e.g., via network interface 240, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### III. EXAMPLES OF CERTAIN TERMS

In some embodiments, the term “multi-class ensemble classification model” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). A multi-class ensemble classification model may include any type of model configured, trained, and/or the like to generate a classification output for an input data object. A multi-class ensemble classification model may include one or more of any type of machine learning model including one or more supervised, unsupervised, semi-supervised, reinforcement learning models, and/or the like.

In some examples, the multi-class ensemble model may include a plurality of connected machine learning models that are arranged and trained at least partially end-to-end in an ensemble model architecture. The plurality of connected machine learning models, for example, may include one or more machine learning class-agnostic models and/or machine learning class-specific models. For instance, a multi-class ensemble classification model may include one or more connected model stages (e.g., one or more sub-models, one or more modules, one or more functions, and/or the like), such as a first model stage including a first set of machine learning models configured to perform one or more first operations and a second model stage including a second set of machine learning models configured to perform one or more second operations. The first and second model stages may be connected such that the one or more second operations may leverage outputs from the one or more first operations. For example, a multi-class ensemble classification model may include a first model stage (e.g., one or more machine learning class-agnostic models) configured to extract one or more features from an input data object and a second model stage (e.g., one or more machine learning class-specific models) configured to generate a label specific feature map for a particular class based on the one or more extracted features.

In some examples, a multi-class ensemble classification model may include an aggregation layer configured to generate a classification output from one or more intermediate representations, such as the extracted features of the first stage, a label specific feature map of the second stage, and/or the like. In some examples, an aggregation layer may include a max pooling function configured to identify and output a maximum classification score from a set of intermediate representations generated during one or more stages of the multi-class ensemble classification model.

A multi-class ensemble classification model may be configured to split an input data object, such as a document containing text, into one or more overlapping data chunks. Each overlapping data chunk may be input to a first, machine learning class-agnostic model, such as a language model feature extractor, and a second, machine learning class-specific model, such as an attention module including a linear layer to produce scores for multi-label classification. In some examples, a machine learning class-agnostic model (e.g., a language model feature extractor, etc.) and machine learning class-specific model (e.g., an attention model, etc.) may formulate an instance of a base classification model of a multi-class ensemble classification model.

In some examples, a multi-class ensemble classification model may include an instance for each data chunk of an input data object. For example, a multi-class ensemble classification model may include a first model stage with a plurality of machine learning class-agnostic models, each configured to generate an intermediate representation for an overlapping data chunk split from the input data object. In some examples, the multi-class ensemble classification model may include a second model stage with a plurality of machine learning class-specific models, each configured to generate a class-specific intermediate representation for an overlapping data chunk based on a corresponding intermediate feature representation. In some examples, a multi-class ensemble classification model may generate a class score for each overlapping data chunk based on the corresponding class-specific intermediate representation.

In some examples, a multi-class ensemble classification model may include an aggregation layer configured to select the class score with the highest value from a plurality of class scores respectively corresponding to a plurality of data chunks of an input data object as a classification output from the multi-class ensemble classification model. The aggregation layer, for example, may include a pooling function, such as a max pooling function, a mean pooling function, and/or the like. By way of example, max pooling may be applied over logits of all overlapping data chunks for the prediction of class predictions. In some examples, the classification output may include the selected class score and the data chunk corresponding to the class score.

In some embodiments, a multi-class ensemble classification model instantiates a machine learning class-agnostic model and machine learning class-specific model for each data chunk of an input data object. In some examples, the machine learning class-specific model may include an ensemble of linear layers for generating a plurality of prediction scores for each of a plurality of target prediction classes of a multi-class prediction domain. In this manner, a single intermediate feature representation may be processed by a plurality of different machine learning models (e.g., linear layers within a machine learning class-specific model, etc.) to generate a plurality of class scores for a data chunk that respectively correspond to a plurality of prediction classes within a complex multi-class prediction domain.

In some embodiments, the term “multi-class prediction domain” refers to a prediction domain associated with a plurality of defined prediction classes. A multi-class prediction domain, for example, may include a plurality of prediction classes that are respectively associated with a predictive insight within the prediction domain. Each of the prediction classes, for example, may include a class label that reflects a predictive insight within the prediction domain.

The plurality of prediction classes of a multi-class prediction domain may depend on the subject matter of the domain. For instance, a multi-class prediction domain may include a plurality of medical codes for a clinical prediction domain, a plurality of building codes for a construction prediction domain, a plurality aviation codes for an aerospace prediction domain, and/or any other types of codes for any multi-class problem space.

As one example, the multi-class prediction domain may include a clinical domain and the multi-class ensemble classification model may be configured for a disease modeling scenario in which one or more disease classifications may be predicted for an input data object. Using one or more of the techniques of the present disclosure, a complex multi-class prediction domain, such as a disease modeling scenario, may be separated into a plurality of binary classification problems in which each prediction class of the multi-class prediction domain is individually assessed by an instance of a machine learning model, such as the multi-class ensemble classification model. By way of example, in a disease classification scenario, each instance of the multi-class ensemble model may predict or impute one or more conditions for an individual from individual segments of a clinical document. By breaking the input clinical document into individual text segments, the multi-class ensemble model may simplify an input for performing a complex, multi-class prediction. This may allow each instance of the multi-class ensemble model to generate multi-class predictions, using class-specific attention models for each target condition defined within a disease classification scenario. In this way, a plurality of conditions, such as heart failure, diabetes, chronic kidney disease, and/or the like, may be individually assessed by a multi-class ensemble model.

In some embodiments, the term “prediction class” refers to a category or identifier for a specific feature, element, or item within a multi-class prediction domain. For example, a prediction domain, such as a multi-class prediction domain may include a plurality of prediction classes, where each prediction class identifies or otherwise corresponds to a specific item or concept. In one example, a medical code or a medical code identifier (e.g., one or more characters) may be an example of a prediction class. In such example, a prediction class may correspond to a medical condition, which may be described, alluded to, or referenced in at least a segment of a medical document.

In some embodiments, the term “input data object” refers to a unit or quantity of data that is input to a model, such as a multi-class ensemble classification model. An input data object may include one or more data elements or tokens, such as words, numbers, abbreviations, and/or the like. For example, a document including any quantity of words, numbers, abbreviations, and/or the like may be an example of an input data object. In some examples, an input data object may include one or more paragraphs each including one or more sentences. Additionally, or alternatively, an input data object may include data that is not in sentence or paragraph form. For example, an input data object may be a table including one or more fields, where each field includes one or more words, numbers, abbreviations, symbols, characters, and/or the like.

In some embodiments, an input data object includes natural language and/or structured language text. For instance, an input data object may include a standardized document, a natural language document, and/or the like. In some examples, an input data object may include natural language text, such as a note, record, and/or the like, written, typed, and/or otherwise recorded manually and/or automatically by a human and/or artificial agent (e.g., large language model, etc.). By way of example, in a clinical domain, an input data object may include a physician note transcribed and uploaded by a medical professional. In accordance with the clinical example, a medical professional may generate and/or modify an input data object after an examination of a patient by updating a patient's medical record with one or more insights from the examination. In such a case, the input data object may include a medical record with information associated with one or more medical conditions, and in turn, associated with one or more prediction classes defined in a disease modeling domain. For example, the input data object may include one or more words that describe one or more symptoms associated with a prediction class. Additionally, or alternatively, the input data object may include one or more words that explicitly indicate one or more prediction classes. The input data object may then be input to a model, such as a multi-class ensemble classification model, which may output one or more prediction classes (e.g., predicted medical codes) based on the input data object (e.g., based on the one or more words in the medical record).

In some embodiments, the term “overlapping data chunk” refers to a segment of text from an input data object. An overlapping data chunk may include two or more portions of text. A first portion of text in a first overlapping data chunk may include a configurable amount of text from a second overlapping data chunk and a second portion of text in the first overlapping data chunk may not be included in the second overlapping data chunk. The first portion of text may provide context for the second portion of text and ensure that each complete sentence of an input data object is included in one or more overlapping data chunks. By way of example, an overlapping data chunk may include a first portion of text from a preceding text segment within the input data object followed by a second portion of text subsequent to the preceding text segment.

In some embodiments, the term “machine learning class-agnostic model” refers to a data entity that describes parameters, hyper-parameters, and/or defined operations of a rules-based and/or machine learning model (e.g., a model including at least one of one or more rule-based layers, one or more layers that depend on trained parameters, coefficients, and/or the like). A machine learning class-agnostic model may include any type of model configured, trained, and/or the like to generate an intermediate feature representation for at least a portion of an input data object. A machine learning class-agnostic model may include one or more of any type of machine learning model including one or more supervised, unsupervised, semi-supervised, reinforcement learning models, and/or the like.

In some examples, a machine learning class-agnostic model may include a feature extraction model that is configured to extract predictive features from a text segment, such as an overlapping data chunk, that may be applicable to one or more of a plurality of prediction classes within a multi-class prediction domain. For example, a machine learning class-agnostic model may generate and identify features or patterns from one or more input data objects without categorizing features or patterns based on specific prediction classes. By way of example, a machine learning class-agnostic model may include a pretrained encoder language model, such as a Bidirectional Encoder Representations from Transformers (BERT) model. In some examples, the machine learning class-agnostic model may be pretrained on a synonymous description of class terms. A synonymous description of class terms, for example, may include a plurality of historical input data objects and/or domain-specific texts corresponding to one or more prediction classes defined by a multi-class prediction domain. By way of example, a machine learning class-agnostic model may include a clinical, pretrained encoder language model that is trained using a clinical dataset including a plurality of clinical-related texts, such as historical medical records, clinical taxonomies, research papers, and/or the like.

As described herein, in some examples, a machine learning class-agnostic model may form a first stage of a multi-class ensemble classification model. For example, a machine learning class-agnostic model may encode one or more features extracted from a text segment, such as an overlapping data chunk, to generate an intermediate feature representation for the text segment. The intermediate feature representation may be provided as input to one or more subsequent stages of the multi-class ensemble classification model. By way of example, an intermediate feature representation may be provided as input to a machine learning class-specific model that forms a second stage of the multi-class ensemble classification model.

In some embodiments, the term “intermediate feature representation” refers to a representation of a portion of data from an input data object. In some examples, an intermediate feature representation may be generated by a model, such as a machine learning class-agnostic model. An intermediate feature representation may be a numerical representation of one or more words, word frequencies, and/or the like from at least a portion of an input data object. For example, an intermediate feature representation may include a feature embedding that represents one or more words from a medical note and/or medical record. In some examples, an intermediate feature representation may be an embedding for an overlapping data chunk that is generated by a machine learning class-agnostic model.

In some embodiments, the term “machine learning class-specific model” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). A machine learning class-specific model may include any type of model configured, trained, and/or the like to generate a class-specific intermediate representation for at least a portion of an input data object. A machine learning class-specific model may include one or more of any type of machine learning model including one or more supervised, unsupervised, semi-supervised, reinforcement learning models, and/or the like.

In some examples, the machine learning class-specific model may include a class-specific attention mechanism that is configured to attend to (e.g., weight, etc.) one or more features from an intermediate feature representation with respect to a particular prediction class of a multi-class prediction domain. For example, the machine learning class-specific model may be configured to perform one or more attention operations to generate a class-specific intermediate representation (e.g., a label-specific feature map) from an intermediate feature representation of a text segment, such as an overlapping data chunk.

As described herein, in some examples, a machine learning class-specific model may form a second stage of a multi-class ensemble classification model. For example, a machine learning class-specific model may weight one or more features extracted from a text segment, such as an overlapping data chunk, to generate a class-specific intermediate representation for the text segment. The class-specific intermediate representation may be provided as input to one or more subsequent stages of the multi-class ensemble classification model. By way of example, a class-specific intermediate representation may be provided as input to an activation function that is configured to generate a class score for text segment from the class-specific intermediate representation. The class score may be leveraged by an aggregation layer of the multi-class ensemble classification model to generate a classification output.

In some embodiments, a machine learning class-specific model is a class-specific attention model that is trained using a semantic sentence description of class specific terms. For instance, a machine learning class-specific model may include one or more different attention model architectures, including a multi-head attention model architecture and/or a language-based attention model architecture. Each architecture may be trained, end-to-end, over one or more self-supervised pretraining and/or supervised fine-tuning training operations. For example, the machine learning class-specific model may be trained (e.g., fine-tuned, etc.), using backpropagation of errors, to optimize a loss function (e.g., classification loss, etc.) with respect to a semantic sentence description of class specific terms.

In some examples, for a multi-class prediction domain, a multi-class ensemble classification model may include a different machine learning class-specific model (and/or a portion thereof) for each of one or more target prediction classes. Each machine learning class-specific model (and/or a linear layer thereof, etc.) may be individually trained using a semantic sentence description of class specific terms that is tailored to a particular prediction class. For example, a first machine learning class-specific model (and/or a first linear layer of a machine learning class-specific model, etc.) for a first prediction class may be trained using a first semantic sentence description of class specific terms that includes a plurality of historical text segments with corresponding labels for the first prediction class. A second machine learning class-specific model (and/or a second linear layer of a machine learning class-specific model, etc.) for a second prediction class may be trained using a second semantic sentence description of class specific terms that includes a plurality of historical text segments with corresponding labels for the second prediction class. In this manner, a plurality of chunk-based classification probabilities may be generated for each of a plurality intermediate feature representations respectively corresponding to a plurality of overlapping data chunks of an input data object. The plurality of chunk-based classification probabilities may be leveraged to generate a plurality of class scores for each target prediction class from the multi-class prediction domain.

In some embodiments, the term “semantic sentence description of class specific terms” refers to a data structure that describes a plurality of labelled training pairs for a prediction class of a multi-class prediction domain. An example semantic sentence description of class specific terms may include any type (and any number) of data storage structures including, as examples, one or more linked lists, databases (e.g., relational databases, graph database, etc.), and/or the like.

In some embodiments, an example semantic sentence description of class specific terms may include a plurality of labeled text segments, each reflective of a ground truth class prediction for a training text segment. A ground truth class prediction, for example, may include a binary class label for a particular prediction class that is reflective of whether a training text segment corresponds to the particular prediction class. The plurality of labeled text segments may include historical text segments, manually generated and/or verified text segments, and/or the like. For example, in a clinical domain, a semantic sentence description of class specific terms may include one or more training text segments from one or more historical, synthetic, and/or augmented medical records. Each of the training text segments may include a ground truth label with respect to a medical code of the semantic sentence description of class specific terms that reflects whether the training text segment includes information sufficient to assign the medical code to the medical record. In this manner, a complex multi-class problem, such as a disease classification scenario, may be treated as a binary classification problem in which each of a plurality of machine learning class-specific models are trained to learn a relationship between text segments and a particular prediction class from the multi-class prediction domain.

In some embodiments, the term “multi-head attention model” refers to a type of a machine learning class-specific model with a multi-layered attention architecture. A multi-head attention model may include a plurality of connected machine learning and activation layers that are collectively configured to generate a class score for a one or more target prediction classes from an intermediate feature representation. For example, a multi-head attention model may include one or more first linear layers (e.g., neural network layers, etc.) that are configured to transform an intermediate feature representation to one or more intermediate hidden representations. In some examples, a multi-head attention model may include a first linear layer for each of the one or more target prediction classes to generate an intermediate hidden representation for each for the one or more target prediction classes. The linear layer for each of the one or more target prediction classes may be connected to an activation function, such as a SoftMax function, and/or the like, to generate a plurality of attention weights for each of the one or more target prediction classes. The plurality of attention weights for each of the one or more target prediction classes may be applied to the intermediate feature representation to generate a class-specific intermediate representation for each of the one or more target prediction classes. For instance, the plurality of attention weights for a particular prediction class may be multiplied by an intermediate feature representation to generate the chunk-based classification probabilities. In this manner, label specific features may be extracted from an intermediate feature representation of a text segment, such as an overlapping data chunk. In some examples, a multi-head attention model may include one or more second linear layers that may be applied to the one or more chunk-based classification probabilities to generate one or more predictions for the one or more target prediction classes.

In some embodiments, a multi-head attention model exhibits one or more performance characteristics with respect to a complexity level. For example, the multi-head attention model may have a recorded performance (e.g., accuracy, etc.) with respect to one or more prediction classes associated with one or more different defined complexity levels. In some examples, a multi-class ensemble classification model may selectively apply a multi-head attention model to a first subset of prediction classes that are associated with a first subset of complexity levels in which the multi-head attention model has a recorded performance that achieves a performance threshold.

In some embodiments, the term “class-specific intermediate representation” refers to a representation of a portion of data from an input data object. In some examples, a class-specific intermediate representation may be generated by a model, such as a machine learning class-specific model and/or portion (e.g., linear layer, etc.) thereof. Additionally, or alternatively, a class-specific intermediate representation may be based on a given prediction class or label. A class-specific intermediate feature representation may be a numerical representation of one or more words, word frequencies, and/or the like from at least a portion of an input data object. For example, a class-specific intermediate feature representation may include a feature embedding that represents one or more words from a medical note and/or medical record. In some examples, a class-specific intermediate feature representation may be an embedding for an overlapping data chunk that is generated by a machine learning class-specific model.

In some embodiments, the term “language-based attention model” refers to a machine learning class-specific model with a language-based attention architecture. In some examples, a language-based attention model may incorporate prior knowledge in the form of adjacent class terms for a particular prediction class. The adjacent class terms, for example, may be extracted, using one or more language processing techniques, from a synonymous description of class terms, such as standard medical code ontologies for a clinical domain. A language-based attention model may leverage the adjacent class terms to attend features of an intermediate feature representation with respect to both a prediction class and adjacent class terms to the prediction class. This may improve the performance of the language-based attention model with rare prediction classes with limited training samples.

More particularly, a language-based attention model may include one or more linear layers (e.g., neural network layers, etc.), one or more pretrained language models (e.g., BERT, etc.), and/or one or more activation functions (e.g., SoftMax functions, etc.), one or more combinatorial functions (e.g., einsum functions, etc.), and/or one or more pooling functions. In some examples, a language-based attention model may connect one or more linear layers with one or more pretrained language models to incorporate prior knowledge of each prediction class to a class-specific intermediate representation. For example, a pretrained language model may include a domain-specific transformer, such as BERT, and/or any other type of language model, to extract features from domain-specific text as synonyms for a particular prediction class. By way of example, in a clinical domain the prior knowledge may reflect code synonyms for a description of a medical code that is associated with semantic knowledge about adjacent forms of the medical code.

In some embodiments, a language-based attention model may include one or more first linear layers (e.g., neural network layers, etc.) that are configured transform an intermediate feature representation to one or more intermediate hidden representations. In some examples, a language-based attention model may include a first linear layer for each of the one or more target prediction classes to generate an intermediate hidden representation for each for the one or more target prediction classes. A second linear layer for a target prediction class may be connected to a pretrained language model that is pretrained to generate one or more class adjacent hidden representations for the target prediction class. In some examples, a first linear layer may be connected to the pretrained language model by a combinatorial function, such as an einsum function, that is configured to merge an intermediate hidden representation with the one or more class adjacent hidden representations to generate one or more similarity scores between synonymous class terms and input features.

In some examples, an activation function, such as a Softmax function, may be leveraged to attend input features from a hidden feature representation for a text segment, such as an overlapping data chunk, to synonym features of a class adjacent hidden representation to generate a combined class adjacent hidden representation for each of one or more synonyms for a prediction class. A language-based attention model may include a pooling function, such as a max pooling function, and/or the like, configured to identify a class-specific intermediate representation (e.g., a maximum representation, etc.) of the combined class adjacent hidden representation for each of one or more synonyms for a prediction class, which may represent the most reliable representation for each prediction class. A language-based attention model may include a third linear layer that may be applied to the class-specific intermediate representation to generate a class score for a prediction class. In this manner, a language-based attention model may apply both label-attention and synonym matching may be applied in the binary classification scenario, such as a disease imputation and prediction setting in which a hierarchical medical code is defined as having at least one of many sub-medical codes.

In some embodiments, a language-based attention model exhibits one or more second performance characteristics and/or corresponds to a second complexity level. For example, the language-based attention model (e.g., one or more outputs of the language-based attention model) may have a second recorded performance (e.g., a second accuracy, etc.) and the multi-head attention model (e.g., one or more outputs of the multi-head attention model) may have a first recorded performance (e.g., a first accuracy, etc.). The second recorded performance may correspond to one or more prediction classes associated with one or more different defined complexity levels. In some examples, the multi-class ensemble classification model may selectively apply a multi-head attention model to a first subset of prediction classes that are associated with a first subset of complexity levels in which the multi-head attention model has a recorded performance that achieved a performance threshold. In some examples, the multi-class ensemble classification model may include or otherwise be configured to utilized one or more language-based attention models. In some examples, one or more processors (e.g., one or more processors that execute the multi-class ensemble classification model) may select or otherwise to determine to utilize the language-based attention model as an alternative to a first type of attention model, such as a multi-head attention model.

In some embodiments, the term “class adjacent hidden representation” refers to a representation of an adjacent class term. For example, a class adjacent hidden representation may be a representation of a synonym for a prediction class, such as a medical code in a clinical scenario. In some examples, a class adjacent hidden representation may be generated by a model, such as a transformer encoder model (e.g., BERT, etc.). A class adjacent hidden representation may be a numerical representation of one or more words, word frequencies, and/or the like from at least a portion of an input data object. For example, a class adjacent hidden representation may include a feature embedding that represents one or more words from a medical note and/or medical record. In some examples, a class adjacent hidden representation may be an embedding for an overlapping data chunk that is generated by a machine learning class-specific model.

In some embodiments, the term “adjacent class term” refers to a term indicative of a label or prediction class that is synonymous or otherwise similar to one or more other class terms. An adjacent class term may be a word, multiple words, a number, and/or multiple numbers that refer to a same prediction class as one or more other words, numbers, and/or the like. For example, in a clinical domain, the word “diabetes” and “insulin” may be adjacent class terms. As another illustrative example, a first medical code indicative of diabetes may be an adjacent class term for a second medical code (e.g., a sub-code) indicative of type-1 diabetes.

In some embodiments, the term “class score” refers to a value representative of a probability that a given portion of data is associated with a specific prediction class. For example, in a clinical domain, a class score may represent a likelihood that a portion of text from an input data object is associated with a specific medical code. In some examples, a class score may be represented by a percentage and/or a decimal value. In some examples, a class score may be utilized to determine a class prediction. For example, a class prediction may indicate a maximum or highest class score of a plurality of class scores.

In some embodiments, the term “classification output” refers to information provided by a model, such as a multi-class ensemble classification model. A classification output may include one or more predictions and/or one or more indications of contextual information utilized by the multi-class ensemble classification model to generate the one or more predictions. In one example, the classification output of the multi-class ensemble classification model may include one or more classes (e.g., one or more class predictions) for an input data object. Additionally, or alternatively, the classification output may include one or more data chunks (e.g., one or more overlapping data chunks) that were used to determine the one or more class predictions. For example, in a clinical domain, a multi-class ensemble classification model may output one or more predicted medical codes and/or one or more portions of a medical document used to predict the one or more medical codes.

More particularly, a classification output may include one or more class predictions, such as one or more prediction classes, and/or one or more overlapping data chunks corresponding to the one or more class predictions. In some examples, a classification output may be based on a plurality of class scores respectively generated for each of a plurality of overlapping data chunks from an input data object and for each one or more target prediction classes. For example, a class prediction may include a maximum class score from the plurality of class scores. In some examples, a class prediction may include a prediction class in the event that the maximum score for the prediction class achieves a prediction threshold. In some examples, the one or more overlapping data chunks may include an overlapping data chunk for each of the prediction classes of the classification output. For instance, an overlapping data chunk for a prediction class may include the overlapping data chunk that corresponds to a maximum class score for the prediction class. In this manner, the classification output may inherently provide explainability for each of one or more prediction classes generated for an input data object.

In some embodiments, the term “class prediction” refers to an output of a model that indicates a prediction class associated with an input or a portion of an input to the model. For example, a multi-class ensemble classification model may receive an input data object and may generate one or more class predictions for the input data object. The one or more class predictions may include one or more medical codes associated with one or more overlapping data chunks from the input data object. In some examples, a class prediction may be based on one or more class scores. For example, a multi-class ensemble classification model may output a class prediction indicative of a prediction class with a maximum class score when compared to other class score for a plurality of other classes.

In some embodiments, the term “classification threshold” refers to a threshold for determining whether a given prediction class is predicted or otherwise output by a model. A classification threshold may be a value or level of a class score, which may be expressed as a percentage and/or a decimal. In one illustrative example, a classification threshold may be 90%. In such an example, a multi-class ensemble classification model may generate and/or output one or more class predictions for one or more prediction classes having class scores of 90% or higher. In some examples, a classification threshold may be used to determine whether a classification output is provided. For example, if a class score for a prediction class satisfies (e.g., is greater than or equal to) a classification threshold, a multi-class ensemble classification model may provide a classification output including a class prediction and an overlapping data chunk corresponding to the class prediction.

### IV. OVERVIEW

Various embodiments of the present disclosure address technical challenges related to machine learning, including the lack of explainability for traditional machine learning techniques. In a variety of data-intensive applications, machine learning techniques may be applied to interpret and make predictive inferences for various types of source documents including unstructured or structured textual data. In some cases, machine learning models may be applied as black boxes configured to generate classification for a document based on the unstructured or structured textual data. Even the most state-of-the-art models are susceptible to classification errors, which hinders the application of machine learning to high priority data including clinical data where an inaccurate classification may result in significant hardship. Due to a lack of explainability, source documents for sensitive information domains may require manual validation to accommodate machine learning deficiencies including model biases, and/or the like that may lead to inaccurate predictions. Various embodiments of the present disclosure make important contributions to existing machine learning techniques by addressing these technical challenges.

Various embodiments of the present disclosure provide systems and methods for improving the performance and explainability of traditional machine learning models using new machine learning model architectures configured to generate explainable predictions. For example, techniques of the present disclosure involve the generation of a classification output from an input data object. The classification output may include a class prediction for the input data object and context information for the class prediction, such as a portion of the input data object that the class prediction was derived from. To do this, a multi-class ensemble classification model may be utilized. For example, multiple types of machine learning models may be utilized in combination to generate a classification output. By combining multiple types of machine learning models as described herein, the accuracy of various classification tasks may be improved when compared to conventional machine learning techniques. Moreover, unlike traditional machine learning techniques, the multi-class ensemble classification model implicitly provides explainability by recording and providing a portion of an input data object from which a class prediction is derived. In this way, some techniques of the present disclosure may improve both the performance and reliability of traditional machine learning techniques, while providing prediction transparency that is lacking in traditional black box systems.

Examples of technologically advantageous embodiments of the present disclosure include improved machine learning techniques that leverage improved model architectures to improve both the performance and explainability of machine learning models, among other examples. Other technical improvements and advantages may be realized by one of ordinary skill in the art.

### V. EXAMPLE SYSTEM OPERATIONS

As indicated, various embodiments of the present disclosure make important technical contributions to machine learning technologies. In particular, systems and methods are disclosed herein that enable the generation of explainable predictions. When compared to traditional techniques, some of the techniques of the present disclosure provide increased prediction transparency and reliability, among other technical advantages.

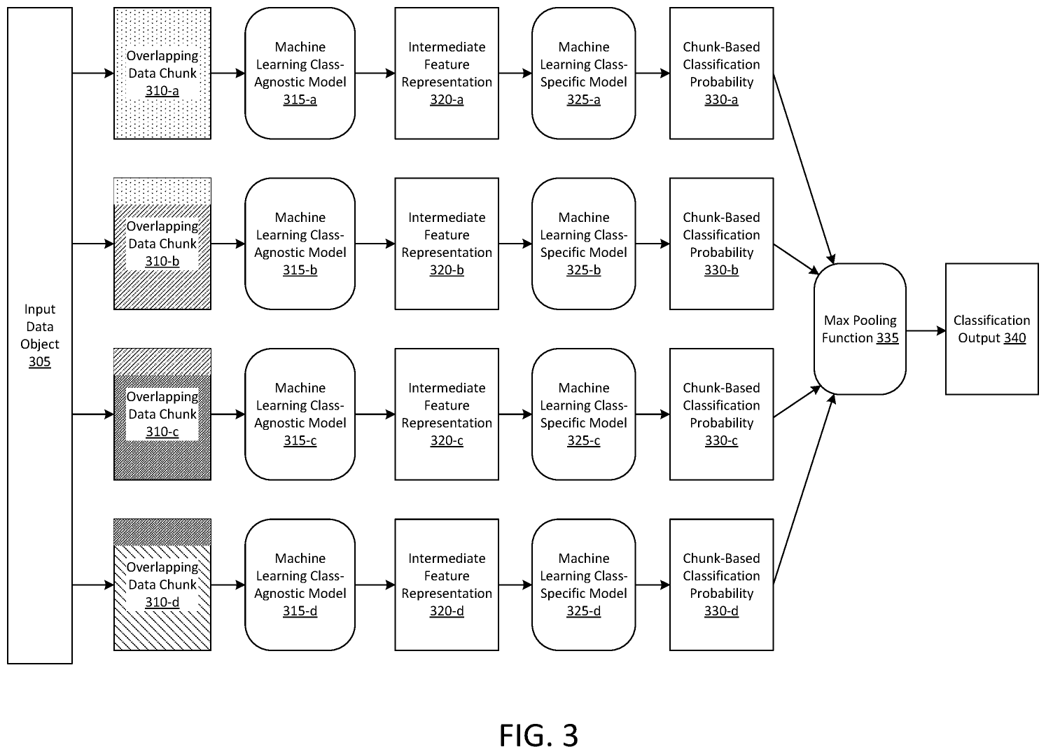

FIG. 3 is a dataflow diagram 300 showing example data structures and modules for generating explainable medical code predictions in accordance with some embodiments discussed herein. The dataflow diagram 300 illustrates data structures and modules for generating a classification output 340 from an input data object 305. As described herein, the classification output 340 may include a class prediction for the input data object 305 and an overlapping data chunk 310 that corresponds to the class prediction, thereby providing one or more users with explanatory information (e.g., the overlapping data chunk 310) for the class prediction. Generating the classification output 340 that includes the class prediction and the overlapping data chunk may increase prediction transparency and reliability, among other technical advantages.

In some examples, one or more processors may generate a plurality of overlapping data chunks from an input data object 305. In some embodiments, an input data object 305 is a unit or quantity of data that is input to a model, such as a multi-class ensemble classification model. An input data object 305 may include one or more data elements or tokens, such as words, numbers, abbreviations, and/or the like. For example, a document including any quantity of words, numbers, abbreviations, and/or the like may be an example of an input data object 305. In some examples, an input data object 305 may include one or more paragraphs each including one or more sentences. Additionally, or alternatively, an input data object 305 may include data that is not in sentence or paragraph form. For example, an input data object 305 may be a table including one or more fields, where each field includes one or more words, numbers, abbreviations, symbols, characters, and/or the like.

In some embodiments, an input data object 305 includes natural language and/or structured language text. For instance, an input data object 305 may include a standardized document, a natural language document, and/or the like. In some examples, an input data object 305 may include natural language text, such as a note, record, and/or the like, written, typed, and/or otherwise recorded manually and/or automatically by a human and/or artificial agent (e.g., large language model, etc.). By way of example, in a clinical domain, an input data object 305 may include a physician note transcribed and uploaded by a medical professional. In accordance with the clinical example, a medical professional may generate and/or modify an input data object 305 after an examination of a patient by updating a patient's medical record with one or more insights from the examination. In such a case, the input data object 305 may include a medical record with information associated with one or more medical conditions, and in turn, associated with one or more prediction classes defined in a disease modeling domain. For example, the input data object 305 may include one or more words that describe one or more symptoms associated with a prediction class. Additionally, or alternatively, the input data object 305 may include one or more words that explicitly indicate one or more prediction classes. The input data object 305 may then be input to a model, such as a multi-class ensemble classification model, which may output one or more prediction classes (e.g., predicted medical codes) based on the input data object 305 (e.g., based on the one or more words in the medical record).

In some embodiments, an overlapping data chunk is a segment of text from an input data object 305. An overlapping data chunk may include two or more portions of text. A first portion of text in a first overlapping data chunk may include a configurable amount of text from a second overlapping data chunk and a second portion of text in the first overlapping data chunk may not be included in the second overlapping data chunk. The first portion of text may provide context for the second portion of text and ensure that each complete sentence of an input data object 305 is included in one or more overlapping data chunks 310. By way of example, an overlapping data chunk may include a first portion of text from a preceding text segment within the input data object 305 followed by a second portion of text subsequent to the preceding text segment.

In some examples, one or more processors may generate a plurality of intermediate feature representations 320 respectively corresponding to the plurality of overlapping data chunks 310. The one or more processors may generate the plurality of intermediate feature representations 320 using a machine learning class-agnostic model 315. In some embodiments, a machine learning class-agnostic model 315 is a data entity that describes parameters, hyper-parameters, and/or defined operations of a rules-based and/or machine learning model (e.g., a model including at least one of one or more rule-based layers, one or more layers that depend on trained parameters, coefficients, and/or the like). A machine learning class-agnostic model 315 may include any type of model configured, trained, and/or the like to generate an intermediate feature representation for at least a portion of an input data object 305. A machine learning class-agnostic model 315 may include one or more of any type of machine learning model including one or more supervised, unsupervised, semi-supervised, reinforcement learning models, and/or the like.

In some examples, a machine learning class-agnostic model 315 may include a feature extraction model that is configured to extract predictive features from a text segment, such as an overlapping data chunk, that may be applicable to one or more of a plurality of prediction classes within a multi-class prediction domain. For example, a machine learning class-agnostic model 315 may generate and identify features or patterns from one or more input data objects 305 without categorizing features or patterns based on specific prediction classes. By way of example, a machine learning class-agnostic model 315 may include a pretrained encoder language model, such as a Bidirectional Encoder Representations from Transformers (BERT) model. In some examples, the machine learning class-agnostic model 315 may be pretrained on a synonymous description of class terms. A synonymous description of class terms, for example, may include a plurality of historical input data objects 305 and/or domain-specific texts corresponding to one or more prediction classes defined by a multi-class prediction domain. By way of example, a machine learning class-agnostic model 315 may include a clinical, pretrained encoder language model that is trained using a clinical dataset including a plurality of clinical-related texts, such as historical medical records, clinical taxonomies, research papers, and/or the like.

As described herein, in some examples, a machine learning class-agnostic model 315 may form a first stage of a multi-class ensemble classification model. For example, a machine learning class-agnostic model 315 may encode one or more features extracted from a text segment, such as an overlapping data chunk 310, to generate an intermediate feature representation for the text segment. The intermediate feature representation may be provided as input to one or more subsequent stages of the multi-class ensemble classification model. By way of example, an intermediate feature representation may be provided as input to a machine learning class-specific model 325 that forms a second stage of the multi-class ensemble classification model.

In some embodiments, an intermediate feature representation is a representation of a portion of data from an input data object 305. In some examples, an intermediate feature representation may be generated by a model, such as a machine learning class-agnostic model 315. An intermediate feature representation may be a numerical representation of one or more words, word frequencies, and/or the like from at least a portion of an input data object 305. For example, an intermediate feature representation may include a feature embedding that represents one or more words from a medical note and/or medical record. In some examples, an intermediate feature representation may be an embedding for an overlapping data chunk 310 that is generated by a machine learning class-agnostic model 315.

In some examples, one or more processors may generate a plurality of chunk-based classification probabilities 330 from the plurality of intermediate representations that correspond to a particular prediction class within a multi-class prediction domain. The one or more processors may generate the plurality of class specific intermediate representations using a machine learning class-specific model 325. In some embodiments, a machine learning class-specific model 325 is a data entity that describes parameters, hyper-parameters, and/or defined operations of a rules-based and/or machine learning model (e.g., model including at least one of one or more rule-based layers, one or more layers that depend on trained parameters, coefficients, and/or the like). A machine learning class-specific model 325 may include any type of model configured, trained, and/or the like to generate a chunk-based classification probability 330 for at least a portion of an input data object 305. A machine learning class-specific model 325 may include one or more of any type of machine learning model including one or more supervised, unsupervised, semi-supervised, reinforcement learning models, and/or the like.

In some examples, the machine learning class-specific model 325 may include a class-specific attention mechanism that is configured to attend to (e.g., weight, etc.) one or more features from an intermediate feature representation with respect to a particular prediction class of a multi-class prediction domain. For example, the machine learning class-specific model 325 may be configured to perform one or more attention operations to generate a chunk-based classification probability 330 (e.g., a label-specific feature map) from an intermediate feature representation of a text segment, such as an overlapping data chunk 310.

As described herein, in some examples, a machine learning class-specific model 325 may form a second stage of a multi-class ensemble classification model. For example, a machine learning class-specific model 325 may weight one or more features extracted from a text segment, such as an overlapping data chunk 310, to generate a chunk-based classification probability 330 for the text segment. The chunk-based classification probability 330 may be provided as input to one or more subsequent stages of the multi-class ensemble classification model. By way of example, a chunk-based classification probability 330 may be provided as input to an activation function that is configured to generate a class score for text segment from the class-specific intermediate representation 330. The class score may be leveraged by an aggregation layer of the multi-class ensemble classification model to generate a classification output 340.

In some embodiments, a machine learning class-specific model 325 is a class-specific attention model that is trained using a semantic sentence description of class specific terms. For instance, a machine learning class-specific model 325 may include one or more different attention model architectures, including a multi-head attention model architecture and/or a language-based attention model architecture. Each architecture may be trained, end-to-end, over one or more self-supervised pretraining and/or supervised fine-tuning training operations. For example, the machine learning class-specific model 325 may be trained (e.g., fine-tuned, etc.), using backpropagation of errors, to optimize a loss function (e.g., classification loss, etc.) with respect to a semantic sentence description of class specific terms.

In some examples, for a multi-class prediction domain, a multi-class ensemble classification model may include a different machine learning class-specific model 325 (and/or a portion thereof) for each of one or more target prediction classes. Each machine learning class-specific model 325 (and/or a linear layer thereof, etc.) may be individually trained using a semantic sentence description of class specific terms that is tailored to a particular prediction class. For example, a first machine learning class-specific model 325 (and/or a first linear layer of a machine learning class-specific model 325, etc.) for a first prediction class may be trained using a first semantic sentence description of class specific terms that includes a plurality of historical text segments with corresponding labels for the first prediction class. A second machine learning class-specific model 325 (and/or a second linear layer of a machine learning class-specific model 325, etc.) for a second prediction class may be trained using a second semantic sentence description of class specific terms that includes a plurality of historical text segments with corresponding labels for the second prediction class. In this manner, a plurality of chunk-based classification probabilities 330 may be generated for each of a plurality intermediate feature representations 320 respectively corresponding to a plurality of overlapping data chunks 310 of an input data object 305. The plurality of chunk-based classification probabilities 330 may be leveraged to generate a plurality of class scores for each target prediction class from the multi-class prediction domain.

In some embodiments, a chunk-based classification probability 330 is a representation of a portion of data from an input data object 305. In some examples, a chunk-based classification probability 330 may be generated by a model, such as a machine learning class-specific model 325 and/or portion (e.g., linear layer, etc.) thereof. Additionally, or alternatively, a chunk-based classification probability 330 may be based on a given prediction class or label. A class-specific intermediate feature representation may be a numerical representation of one or more words, word frequencies, and/or the like from at least a portion of an input data object 305. For example, a class-specific intermediate feature representation may include a feature embedding that represents one or more words from a medical note and/or medical record. In some examples, a class-specific intermediate feature representation may be an embedding for an overlapping data chunk 310 that is generated by a machine learning class-specific model 325.

In some examples, one or more processors may generate, using the plurality of-chunk-based classification probabilities 330, a plurality of class scores for the plurality of overlapping data chunks 310 with respect to the particular prediction class. In some embodiments, a class score is a value representative of a probability that a given portion of data is associated with a specific prediction class. For example, in a clinical domain, a class score may represent a likelihood that a portion of text from an input data object 305 is associated with a specific medical code. In some examples, a class score may be represented by a percentage and/or a decimal value. In some examples, a class score may be utilized to determine a class prediction. For example, a class prediction may indicate a maximum or highest class score of a plurality of class scores.

In some embodiments, a prediction class is a category or identifier for a specific feature, element, or item within a multi-class prediction domain. For example, a prediction domain, such as a multi-class prediction domain may include a plurality of prediction classes, where each prediction class identifies or otherwise corresponds to a specific item or concept. In one example, a medical code or a medical code identifier (e.g., one or more characters) may be an example of a prediction class. In such example, a prediction class may correspond to a medical condition, which may be described, alluded to, or referenced in at least a segment of a medical document.

In some examples, one or more processors may provide a classification output 340 that is (i) based on the plurality of class scores and (ii) comprises (a) a class prediction for the input data object 305 and (b) an overlapping data chunk 310 from the plurality of overlapping data chunks 310 that corresponds to the class prediction. In some embodiments, a classification output 340 is information provided by a model, such as a multi-class ensemble classification model. A classification output 340 may include one or more predictions and/or one or more indications of contextual information utilized by the multi-class ensemble classification model to generate the one or more predictions. In one example, the classification output 340 of the multi-class ensemble classification model may include one or more classes (e.g., one or more class predictions) for an input data object 305. Additionally, or alternatively, the classification output 340 may include one or more data chunks (e.g., one or more overlapping data chunks 310) that were used to determine the one or more class predictions. For example, in a clinical domain, a multi-class ensemble classification model may output one or more predicted medical codes and/or one or more portions of a medical document used to predict the one or more medical codes.

More particularly, a classification output 340 may include one or more class predictions, such as one or more prediction classes, and/or one or more overlapping data chunks 310 corresponding to the one or more class predictions. In some examples, a classification output 340 may be based on a plurality of class scores respectively generated for each of a plurality of overlapping data chunks 310 from an input data object 305 and for each one or more target prediction classes. For example, a class prediction may include a maximum class score from the plurality of class scores. In some examples, a class prediction may include a prediction class in the event that the maximum score for the prediction class achieves a prediction threshold. In some examples, the one or more overlapping data chunks 310 may include an overlapping data chunk 310 for each of the prediction classes of the classification output 340. For instance, an overlapping data chunk 310 for a prediction class may include the overlapping data chunk 310 that corresponds to a maximum class score for the prediction class. In this manner, the classification output 340 may inherently provide explainability for each of one or more prediction classes generated for an input data object 305.

In some embodiments, a class prediction is an output of a model that indicates a prediction class associated with an input or a portion of an input to the model. For example, a multi-class ensemble classification model may receive an input data object 305 and may generate one or more class predictions for the input data object 305. The one or more class predictions may include one or more medical codes associated with one or more overlapping data chunks 310 from the input data object 305. In some examples, a class prediction may be based on one or more class scores. For example, a multi-class ensemble classification model may output a class prediction indicative of a prediction class with a maximum class score when compared to other class score for a plurality of other classes.

In some examples, providing the class prediction and the overlapping data chunk 310 includes identifying, using a max pooling function 335, a maximum class score from the plurality of class scores, identifying the overlapping data chunk 310 that corresponds to the maximum class score, generating the class prediction based on a comparison between the maximum class score and a classification threshold, and providing the class prediction with the overlapping data chunk 310 as an explanation for the class prediction.

In some embodiments, a classification threshold is a threshold for determining whether a given prediction class is predicted or otherwise output by a model. A classification threshold may be a value or level of a class score, which may be expressed as a percentage and/or a decimal. In one illustrative example, a classification threshold may be 90%. In such an example, a multi-class ensemble classification model may generate and/or output one or more class predictions for one or more prediction classes having class scores of 90% or higher. In some examples, a classification threshold may be used to determine whether a classification output 340 is provided. For example, if a class score for a prediction class satisfies (e.g., is greater than or equal to) a classification threshold, a multi-class ensemble classification model may provide a classification output 340 including a class prediction and an overlapping data chunk 310 corresponding to the class prediction.

In some examples, the machine learning class-agnostic model 315 includes a pretrained encoder language model. In some examples, the machine learning class-specific model 325 is one of a plurality of machine learning class-specific models 325 within a multi-class ensemble classification model and each of the plurality of machine learning class-specific models 325 corresponds to a different prediction class within the multi-class prediction domain. In some embodiments, a multi-class ensemble classification model is a data entity that describes parameters, hyper-parameters, and/or defined operations of a rules-based and/or machine learning model (e.g., model including at least one of one or more rule-based layers, one or more layers that depend on trained parameters, coefficients, and/or the like). A multi-class ensemble classification model may include any type of model configured, trained, and/or the like to generate a classification output 340 for an input data object 305. A multi-class ensemble classification model may include one or more of any type of machine learning model including one or more supervised, unsupervised, semi-supervised, reinforcement learning models, and/or the like.

In some examples, the multi-class ensemble model may include a plurality of connected machine learning models that are arranged and trained at least partially end-to-end in an ensemble model architecture. The plurality of connected machine learning models, for example, may include one or more machine learning class-agnostic models 315 and/or machine learning class-specific models 325. For instance, a multi-class ensemble classification model may include one or more connected model stages (e.g., one or more sub-models, one or more modules, one or more functions, and/or the like), such as a first model stage including a first set of machine learning models configured to perform one or more first operations and a second model stage including a second set of machine learning models configured to perform one or more second operations. The first and second model stages may be connected such that the one or more second operations may leverage outputs from the one or more first operations. For example, a multi-class ensemble classification model may include a first model stage (e.g., one or more machine learning class-agnostic models 315) configured to extract one or more features from an input data object 305 and a second model stage (e.g., one or more machine learning class-specific models 325) configured to generate a label specific feature map for a particular class based on the one or more extracted features.

In some examples, a multi-class ensemble classification model may include an aggregation layer configured to generate a classification output 340 from one or more intermediate representations, such as the extracted features of the first stage, a label specific feature map of the second stage, and/or the like. In some examples, an aggregation layer may include a max pooling function 335 configured to identify and output a maximum classification score from a set of intermediate representations generated during one or more stages of the multi-class ensemble classification model.

A multi-class ensemble classification model may be configured to split an input data object 305, such as a document containing text, into one or more overlapping data chunks 310. Each overlapping data chunk 310 may be input to a first, machine learning class-agnostic model 315, such as a language model feature extractor, and a second, machine learning class-specific model 325, such as an attention module including a linear layer to produce scores for multi-label classification. In some examples, a machine learning class-agnostic model 315 (e.g., a language model feature extractor, etc.) and machine learning class-specific model 325 (e.g., an attention model, etc.) may formulate an instance of a base classification model of a multi-class ensemble classification model.

In some examples, a multi-class ensemble classification model may include an instance for each data chunk of an input data object 305. For example, a multi-class ensemble classification model may include a first model stage with a plurality of machine learning class-agnostic models 315, each configured to generate an intermediate representation for an overlapping data chunk 310 split from the input data object 305. In some examples, the multi-class ensemble classification model may include a second model stage with a plurality of machine learning class-specific models 325, each configured to generate a chunk-based classification probability 330 for an overlapping data chunk 310 based on a corresponding intermediate feature representation 320. In some examples, a multi-class ensemble classification model may generate a class score for each overlapping data chunk 310 based on the corresponding chunk-based classification probability 330.

In some examples, a multi-class ensemble classification model may include an aggregation layer configured to select the class score with the highest value from a plurality of class scores respectively corresponding to a plurality of data chunks of an input data object 305 as a classification output 340 from the multi-class ensemble classification model. The aggregation layer, for example, may include a pooling function, such as a max pooling function 335, a mean pooling function, and/or the like. By way of example, max pooling may be applied over logits of all overlapping data chunks 310 for the prediction of class predictions. In some examples, the classification output 340 may include the selected class score and the data chunk corresponding to the class score.

In some embodiments, a multi-class ensemble classification model instantiates a machine learning class-agnostic model 315 and machine learning class-specific model 325 for each data chunk of an input data object 305. In some examples, the machine learning class-specific model 325 may include an ensemble of linear layers for generating a plurality of prediction scores for each of a plurality of target prediction classes of a multi-class prediction domain. In this manner, a single intermediate feature representation 320 may be processed by a plurality of different machine learning models (e.g., linear layers within a machine learning class-specific model 325, etc.) to generate a plurality of class scores for a data chunk that respectively correspond to a plurality of prediction classes within a complex multi-class prediction domain.

In some embodiments, a multi-class prediction domain is a prediction domain associated with a plurality of defined prediction classes. A multi-class prediction domain, for example, may include a plurality of prediction classes that are respectively associated with a predictive insight within the prediction domain. Each of the prediction classes, for example, may include a class label that reflects a predictive insight within the prediction domain.

The plurality of prediction classes of a multi-class prediction domain may depend on the subject matter of the domain. For instance, a multi-class prediction domain may include a plurality of medical codes for a clinical prediction domain, a plurality of building codes for a construction prediction domain, a plurality aviation codes for an aerospace prediction domain, and/or any other types of codes for any multi-class problem space.

As one example, the multi-class prediction domain may include a clinical domain and the multi-class ensemble classification model may be configured for a disease modeling scenario in which one or more disease classifications may be predicted for an input data object 305. Using one or more of the techniques of the present disclosure, a complex multi-class prediction domain, such as a disease modeling scenario, may be separated into a plurality of binary classification problems in which each prediction class of the multi-class prediction domain is individually assessed by an instance of a machine learning model, such as the multi-class ensemble classification model. By way of example, in a disease classification scenario, each instance of the multi-class ensemble model may predict or impute one or more conditions for an individual from individual segments of a clinical document. By breaking the input clinical document into individual text segments, the multi-class ensemble model may simplify an input for performing a complex, multi-class prediction. This may allow each instance of the multi-class ensemble model to generate multi-class predictions, using class-specific attention models for each target condition defined within a disease classification scenario. In this way, a plurality of conditions, such as heart failure, diabetes, chronic kidney disease, and/or the like, may be individually assessed by a multi-class ensemble model. In some examples, the classification output 340 includes a different prediction class prediction and corresponding overlapping data chunk 310 for each of a plurality of prediction classes within the multi-class prediction domain.

In some examples, the machine learning class-specific model 325 includes a multi-head attention model configured to perform one or more operations. The one or more operations may include generating, using a linear layer, a hidden representation for an intermediate feature representation 320 of the plurality of intermediate feature representations 320 based on a particular prediction class, identifying, using an activation function, a plurality of class-specific attention weights from the hidden representation, and generating a chunk-based classification probability 330 for the intermediate feature representation 320 based on the plurality of class-specific attention weights.

In some embodiments, a multi-head attention model is a type of a machine learning class-specific model 325 with a multi-layered attention architecture. A multi-head attention model may include a plurality of connected machine learning and activation layers that are collectively configured to generate a class score for a one or more target prediction classes from an intermediate feature representation 320. For example, a multi-head attention model may include one or more first linear layers (e.g., neural network layers, etc.) that are configured to transform an intermediate feature representation 320 to one or more intermediate hidden representations. In some examples, a multi-head attention model may include a first linear layer for each of the one or more target prediction classes to generate an intermediate hidden representation for each for the one or more target prediction classes. The linear layer for each of the one or more target prediction classes may be connected to an activation function, such as a SoftMax function, and/or the like, to generate a plurality of attention weights for each of the one or more target prediction classes. The plurality of attention weights for each of the one or more target prediction classes may be applied to the intermediate feature representation 320 to generate a chunk-based classification probability 330 for each of the one or more target prediction classes. For instance, the plurality of attention weights for a particular prediction class may be multiplied by an intermediate feature representation 320 to generate the chunk-based classification probabilities 330. In this manner, label specific features may be extracted from an intermediate feature representation 320 of a text segment, such as an overlapping data chunk 310. In some examples, a multi-head attention model may include one or more second linear layers that may be applied to the one or more chunk-based classification probabilities 330 to generate one or more predictions for the one or more target prediction classes.

In some embodiments, a multi-head attention model exhibits one or more performance characteristics with respect to a complexity level. For example, the multi-head attention model may have a recorded performance (e.g., accuracy, etc.) with respect to one or more prediction classes associated with one or more different defined complexity levels. In some examples, a multi-class ensemble classification model may selectively apply a multi-head attention model to a first subset of prediction classes that are associated with a first subset of complexity levels in which the multi-head attention model has a recorded performance that achieves a performance threshold.

In some examples, the machine learning class-specific model 325 includes a language-based attention model configured to perform one or more operations. The one or more operations may include generating, using a machine learning feature extraction model, one or more class adjacent hidden representations 320 for one or more adjacent class terms corresponding to the particular prediction class, generating, using a linear layer, a hidden representation for an intermediate feature representation 320 of the plurality of intermediate feature representations 320 based on a particular prediction class, generating one or more similarity scores between synonymous class terms and input features 320 by merging the hidden representation with the one or more class adjacent hidden representations, identifying, using an activation function, a plurality of class-specific attention weights from the hidden representation, and, generating a chunk-based classification probability 330 for the intermediate feature representation 320 based on the plurality of class-specific attention weights.

In some embodiments, a language-based attention model is a machine learning class-specific model 325 with a language-based attention architecture. In some examples, a language-based attention model may incorporate prior knowledge in the form of adjacent class terms for a particular prediction class. The adjacent class terms, for example, may be extracted, using one or more language processing techniques, from a synonymous description of class terms, such as standard medical code ontologies for a clinical domain. A language-based attention model may leverage the adjacent class terms to attend features of an intermediate feature representation 320 with respect to both a prediction class and adjacent class terms to the prediction class. This may improve the performance of the language-based attention model with rare prediction classes with limited training samples.

More particularly, a language-based attention model may include one or more linear layers (e.g., neural network layers, etc.), one or more pretrained language models (e.g., BERT, etc.), and/or one or more activation functions (e.g., SoftMax functions, etc.), one or more combinatorial functions (e.g., einsum functions, etc.), and/or one or more pooling functions. In some examples, a language-based attention model may connect one or more linear layers with one or more pretrained language models to incorporate prior knowledge of each prediction class to a chunk-based classification probability 330. For example, a pretrained language model may include a domain-specific transformer, such as BERT, and/or any other type of language model, to extract features from domain-specific text as synonyms for a particular prediction class. By way of example, in a clinical domain the prior knowledge may reflect code synonyms for a description of a medical code that is associated with semantic knowledge about adjacent forms of the medical code.

In some embodiments, a language-based attention model may include one or more first linear layers (e.g., neural network layers, etc.) that are configured transform an intermediate feature representation 320 to one or more intermediate hidden representations. In some examples, a language-based attention model may include a first linear layer for each of the one or more target prediction classes to generate an intermediate hidden representation for each for the one or more target prediction classes. A first linear layer for a target prediction class may be connected to a pretrained language model that is pretrained to generate one or more class adjacent hidden representations for the target prediction class. In some examples, a second linear layer may be connected to the pretrained language model by a combinatorial function, such as an einsum function, that is configured to merge an intermediate hidden representation with the one or more class adjacent hidden representations to generate one or more similarity scores between synonymous class terms and input features.

In some examples, an activation function, such as a Softmax function, may be leveraged to attend input features from a hidden feature representation for a text segment, such as an overlapping data chunk 310, to synonym features of a class adjacent hidden representation to generate a combined class adjacent intermediate feature representation for each of one or more synonyms for a prediction class. A language-based attention model may include a pooling function, such as a max pooling function 335, and/or the like, configured to identify a chunk-based classification probability 330 (e.g., a maximum representation, etc.) of the combined class adjacent hidden representation for each of one or more synonyms for a prediction class, which may represent the most reliable representation for each prediction class. A language-based attention model may include a third linear layer that may be applied to the chunk-based classification probability 330 to generate a class score for a prediction class. In this manner, a language-based attention model may apply both label-attention and synonym matching may be applied in the binary classification scenario, such as a disease imputation and prediction setting in which a hierarchical medical code is defined as having at least one of many sub-medical codes.

In some embodiments, a language-based attention model exhibits one or more second performance characteristics and/or corresponds to a second complexity level. For example, the language-based attention model (e.g., one or more outputs of the language-based attention model) may have a second recorded performance (e.g., a second accuracy, etc.) and the multi-head attention model (e.g., one or more outputs of the multi-head attention model) may have a first recorded performance (e.g., a first accuracy, etc.). The second recorded performance may correspond to one or more prediction classes associated with one or more different defined complexity levels. In some examples, the multi-class ensemble classification model may selectively apply a multi-head attention model to a first subset of prediction classes that are associated with a first subset of complexity levels in which the multi-head attention model has a recorded performance that achieved a performance threshold. In some examples, the multi-class ensemble classification model may include or otherwise be configured to utilized one or more language-based attention models. In some examples, one or more processors (e.g., one or more processors that execute the multi-class ensemble classification model) may select or otherwise to determine to utilize the language-based attention model as an alternative to a first type of attention model, such as a multi-head attention model.

In some embodiments, a class adjacent hidden representation is a representation of an adjacent class term. For example, a class adjacent hidden representation may be a representation of a synonym for a prediction class, such as a medical code in a clinical scenario. In some examples, a class adjacent hidden representation may be generated by a model, such as a transformer encoder model (e.g., BERT, etc.). A class adjacent hidden representation may be a numerical representation of one or more words, word frequencies, and/or the like from at least a portion of an input data object 305. For example, a class adjacent hidden representation may include a feature embedding that represents one or more words from a medical note and/or medical record. In some examples, a class adjacent hidden representation may be an embedding for an overlapping data chunk 310 that is generated by a machine learning class-specific model 325.

In some embodiments, an adjacent class term is a term indicative of a label or prediction class that is synonymous or otherwise similar to one or more other class terms. An adjacent class term may be a word, multiple words, a number, and/or multiple numbers that refer to a same prediction class as one or more other words, numbers, and/or the like. For example, in a clinical domain, the word “diabetes” and “insulin” may be adjacent class terms. As another illustrative example, a first medical code indicative of diabetes may be an adjacent class term for a second medical code (e.g., a sub-code) indicative of type-1 diabetes.

In some examples, the overlapping data chunk 310 includes a text segment from the input data object 305 that comprises at least a portion of a preceding text segment from the input data object 305. In some examples, the machine learning class-agnostic model 315 and the machine learning class-specific model 325 are individually pre-trained and finetuned end-to-end. In some examples, the machine learning class-specific model 325 is finetuned using a semantic sentence description of class specific terms. In some embodiments, a semantic sentence description of class specific terms is a data structure that describes a plurality of labelled training pairs for a prediction class of a multi-class prediction domain. An example semantic sentence description of class specific terms may include any type (and any number) of data storage structures including, as examples, one or more linked lists, databases (e.g., relational databases, graph database, etc.), and/or the like.

In some embodiments, an example semantic sentence description of class specific terms may include a plurality of labeled text segments, each reflective of a ground truth class prediction for a training text segment. A ground truth class prediction, for example, may include a binary class label for a particular prediction class that is reflective of whether a training text segment corresponds to the particular prediction class. The plurality of labeled text segments may include historical text segments, manually generated and/or verified text segments, and/or the like. For example, in a clinical domain, a semantic sentence description of class specific terms may include one or more training text segments from one or more historical, synthetic, and/or augmented medical records. Each of the training text segments may include a ground truth label with respect to a medical code of the semantic sentence description of class specific terms that reflects whether the training text segment includes information sufficient to assign the medical code to the medical record. In this manner, a complex multi-class problem, such as a disease classification scenario, may be treated as a binary classification problem in which each of a plurality of machine learning class-specific models 325 are trained to learn a relationship between text segments and a particular prediction class from the multi-class prediction domain.

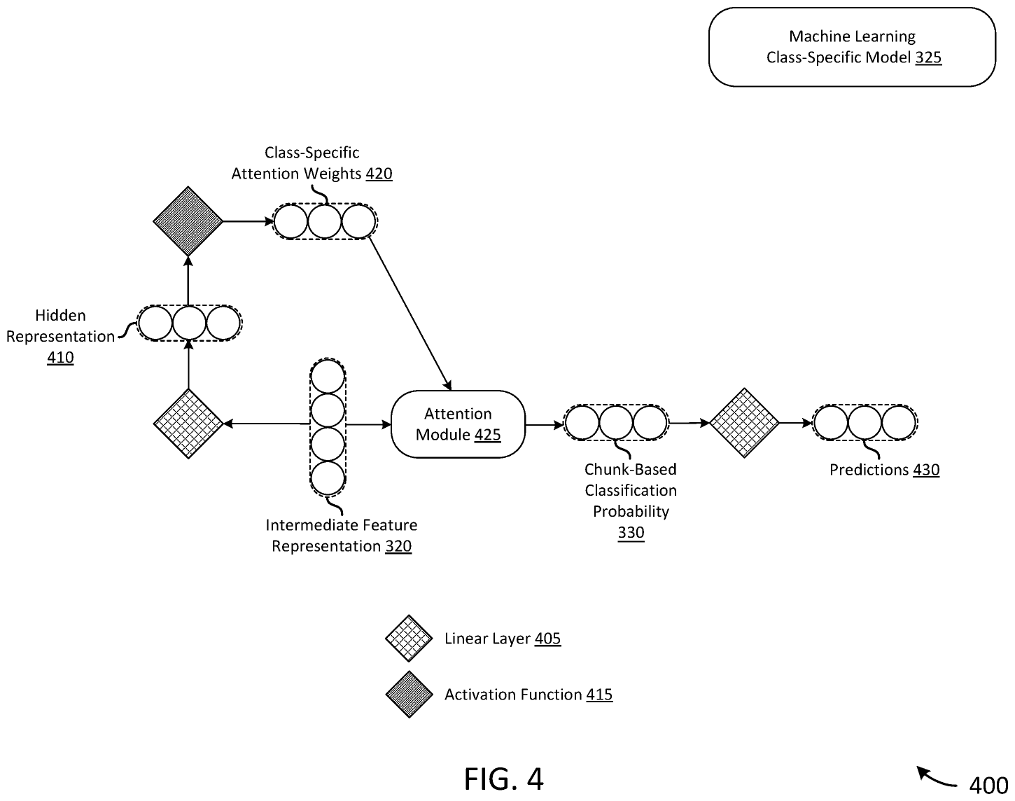

FIG. 4 is a dataflow diagram 400 showing example data structures and modules for generating explainable medical code predictions in accordance with some embodiments discussed herein. More specifically, the dataflow diagram 400 may illustrate example data structures and modules of a machine learning class-specific model 325 (e.g., a first type of machine learning class specific model, a multi-head attention model). As described herein, the machine learning class-specific model 325 may receive an intermediate feature representation 320 as an input and may output a chunk-based classification probability 330.

A multi-head attention model may be a type of a machine learning class-specific model 325 with a multi-layered attention architecture. A multi-head attention model may include a plurality of connected machine learning and activation layers (e.g., the linear layer 405, the activation function 415, the attention module 425) that are collectively configured to generate a class score for a one or more target prediction classes from an intermediate feature representation 320. For example, a multi-head attention model may include one or more first linear layers 405 (e.g., neural network layers, etc.) that are configured transform an intermediate feature representation 320 to one or more intermediate hidden representations 410. In some examples, a multi-head attention model may include a first linear layer 405 for each of the one or more target prediction classes to generate an intermediate hidden representation 410 for each for the one or more target prediction classes. The linear layer 405 for each of the one or more target prediction classes may be connected to an activation function 415, such as a SoftMax function, and/or the like, to generate a plurality of attention weights 420 for each of the one or more target prediction classes. The plurality of attention weights 420 for each of the one or more target prediction classes may be applied to the intermediate feature representation 320 to generate a chunk-based classification probability 330 for each of the one or more target prediction classes. For instance, the plurality of attention weights 420 for a particular prediction class may be multiplied by an intermediate feature representations 320 to generate the chunk-based classification probabilities 330. In this manner, label specific features may be extracted from an intermediate feature representation 320 of a text segment, such as an overlapping data chunk. In some examples, a multi-head attention model may include one or more second linear layers 405 that may be applied to the one or more chunk-based classification probabilities 330 to generate one or more predictions 430 for the one or more target prediction classes.

In some embodiments, a multi-head attention model exhibits one or more performance characteristics with respect to a complexity level. For example, the multi-head attention model may have a recorded performance (e.g., accuracy, etc.) with respect to one or more prediction classes associated with one or more different defined complexity levels. In some examples, a multi-class ensemble classification model may selectively apply a multi-head attention model to a first subset of prediction classes that are associated with a first subset of complexity levels in which the multi-head attention model has a recorded performance that achieved a performance threshold.

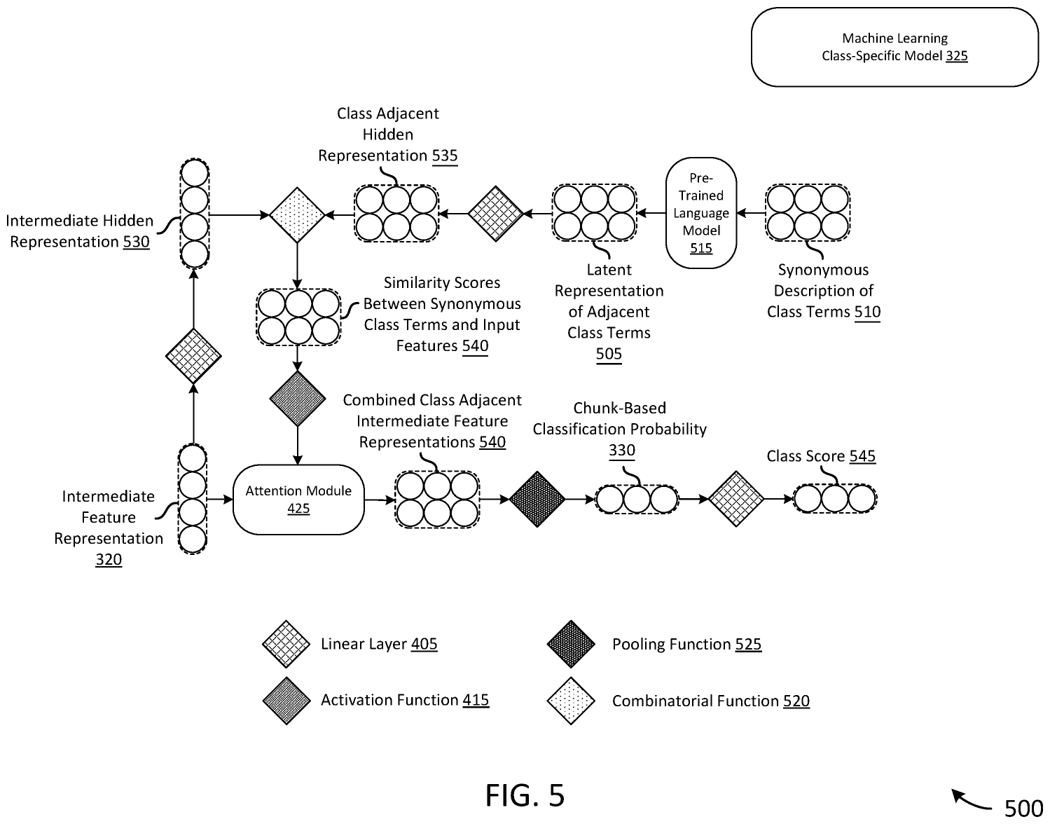

FIG. 5 is a dataflow diagram 500 showing example data structures and modules for generating explainable medical code predictions in accordance with some embodiments discussed herein. More specifically, the dataflow diagram 500 may illustrate example data structures and modules of a machine learning class-specific model 325 (e.g., a second type of machine learning class specific model, a language-based attention model). As described herein, the machine learning class-specific model 325 may receive an intermediate feature representation 320 as an input and may output a chunk-based classification probability 330.

A language-based attention model may be a machine learning class-specific model 325 with a language-based attention architecture. In some examples, a language-based attention model may incorporate prior knowledge in the form of a latent representation of adjacent class terms 505 for a particular prediction class. The latent representation of adjacent class terms 505, for example, may be extracted, using one or more language processing techniques, from a synonymous description of class terms 510, such as standard medical code ontologies for a clinical domain. A language-based attention model (e.g., an attention module 425) may leverage the latent representation of adjacent class terms 505 to attend features of an intermediate feature representation 320 with respect to both a prediction class and a latent representation of adjacent class terms 505. This may improve the performance of the language-based attention model with rare prediction classes with limited training samples.

More particularly, a language-based attention model may include one or more linear layers 405 (e.g., neural network layers, etc.), one or more pretrained language models 515 (e.g., BERT, etc.), and/or one or more activation functions 415 (e.g., SoftMax functions, etc.), one or more combinatorial functions 520 (e.g., einsum functions, etc.), and/or one or more pooling functions 525. In some examples, a language-based attention model may connect one or more linear layers 405 with one or more pretrained language models 515 to incorporate prior knowledge of each prediction class to a chunk-based classification probability 330. For example, a pretrained language model 515 may include a domain-specific transformer, such as BERT, and/or any other type of language model, to extract features from a synonymous description of class terms 510 as a latent representation of adjacent class terms 505 for a particular prediction class. By way of example, in a clinical domain the prior knowledge may reflect code synonyms for a description of a medical code that is associated with semantic knowledge about adjacent forms of the medical code.

In some embodiments, a language-based attention model may include one or more first linear layers 405 (e.g., neural network layers, etc.) that are configured transform an intermediate feature representation 320 to one or more intermediate hidden representations 530. In some examples, a language-based attention model may include a first linear layer 405 for each of the one or more target prediction classes to generate an intermediate hidden representation 530 for each for the one or more target prediction classes. A second linear layer 405 for a target prediction class may be connected to a pretrained language model 515 that is pretrained to generate one or more class adjacent hidden representations 535 for the target prediction class. In some examples, a first linear layer 405 may be connected to the pretrained language model 515 by a combinatorial function 520, such as an einsum function, that is configured to merge an intermediate hidden representation 530 with the one or more class adjacent hidden representations 535 to generate one or more similarity scores between synonymous class terms and input features 540.

In some examples, an activation function 415, such as a Softmax function, may be leveraged to attend input features from a hidden feature representation for a text segment, such as an overlapping data chunk, to synonym features of a class adjacent hidden representation 535 to generate a combined class adjacent intermediate feature representation 540 for each of one or more synonyms for a prediction class. A language-based attention model may include a pooling function 525, such as a max pooling function, and/or the like, configured to identify a chunk-based classification probability 330 (e.g., a maximum representation, etc.) of the combined class adjacent intermediate feature representation 540 for each of one or more synonyms for a prediction class, which may represent the most reliable representation for each prediction class. A language-based attention model may include a third linear layer 405 that may be applied to the chunk-based classification probability 330 to generate a class score 545 for a prediction class. In this manner, a language-based attention model may apply both label-attention and synonym matching may be applied in the binary classification scenario, such as a disease imputation and prediction setting in which a hierarchical medical code is defined as having at least one of many sub-medical codes.

In some embodiments, a language-based attention model exhibits one or more second performance characteristics and/or corresponds to a second complexity level. For example, the language-based attention model (e.g., one or more outputs of the language-based attention model) may have a second recorded performance (e.g., a second accuracy, etc.) and the multi-head attention model (e.g., one or more outputs of the multi-head attention model) may have a first recorded performance (e.g., a first accuracy, etc.). The second recorded performance may correspond to one or more prediction classes associated with one or more different defined complexity levels. In some examples, the multi-class ensemble classification model may selectively apply a multi-head attention model to a first subset of prediction classes that are associated with a first subset of complexity levels in which the multi-head attention model has a recorded performance that achieved a performance threshold. In some examples, the multi-class ensemble classification model may include or otherwise be configured to utilized one or more language-based attention models. In some examples, one or more processors (e.g., one or more processors that execute the multi-class ensemble classification model) may select or otherwise to determine to utilize the language-based attention model as an alternative to a first type of attention model, such as a multi-head attention model.

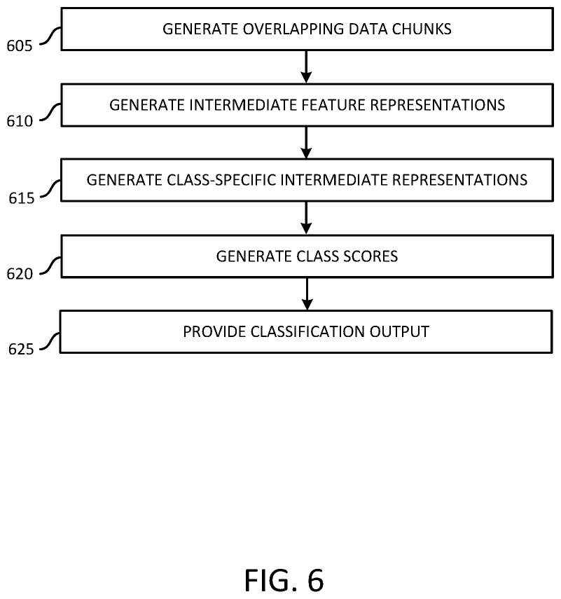

FIG. 6 is a flowchart diagram of an example process 600 for generating explainable predictions in accordance with some embodiments discussed herein. The flowchart depicts a process 600 for implementing a multi-class ensemble model to implicitly generate explainable predictions that provide context for a predictive classification. The process 600 may be implemented by one or more computing devices, entities, and/or systems described herein. For example, via the various steps/operations of the process 600, the computing system 100 may leverage improved machine learning techniques to implicitly generate explainable text for a predictive classification. By doing so, the process 600 facilitates an explainable machine learning technique that is directly tailored to addressing technical challenges of traditional machine learning technologies and may be leveraged to improve both the predictive performance and the explainability of traditional machine learning models.

FIG. 6 illustrates an example process 600 for explanatory purposes. Although the example process 600 depicts a particular sequence of steps/operations, the sequence may be altered without departing from the scope of the present disclosure. For example, some of the steps/operations depicted may be performed in parallel or in a different sequence that does not materially impact the function of the process 600. In other examples, different components of an example device or system that implements the process 600 may perform functions at substantially the same time or in a specific sequence.

In some embodiments, the process 600 includes, at step/operation 605, generating a plurality of overlapping data chunks. For example, the computing system 100 may generate the plurality of overlapping data chunks. In some examples, the plurality of overlapping data chunks may be generated from an input data object.

In some embodiments, the process 600 includes, at step/operation 610, generating a plurality of intermediate feature representations respectively corresponding to the plurality of overlapping data chunks. For example, the computing system 100 may generate the plurality of intermediate feature representations respectively corresponding to the plurality of overlapping data chunks. In some examples, the plurality of intermediate feature representations may be generated using a machine learning class-agnostic model.

In some embodiments, the process 600 includes, at step/operation 615, generating a plurality of chunk-based classification probabilities from the plurality of intermediate representations that correspond to a particular prediction class within a multi-class prediction domain. For example, the computing system 100 may generate the plurality of chunk-based classification probabilities from the plurality of intermediate representations. In some examples, the one or more processors may generate the plurality of chunk-based classification probabilities using a machine learning class-specific model.

In some embodiments, the process 600 includes, at step/operation 620, generating a plurality of class scores for the plurality of overlapping data chunks with respect to the particular prediction class. In some examples, one or more processors of a computer entity may generate the plurality of class scores. In some examples, one or more processors of a computing entity may generate the plurality of class scores using the plurality of chunk-based classification probabilities.

In some embodiments, the process 600 includes, at step/operation 625, providing a classification output. For example, the computing system 100 may provide the classification output. In some examples, the classification output may be based on the plurality of class scores. Additionally, or alternatively, the classification output may include a class prediction for the input data object and an overlapping data chunk from the plurality of overlapping data chunks that corresponds to the class prediction.

Some techniques of the present disclosure enable the generation of action able outputs that may be performed to initiate one or more real world actions to achieve real-world effects. The predictive techniques of the present disclosure may be used, applied, and/or otherwise leveraged to identify medical codes and prediction contextual information, which may improve systems that depend on the identification of medical codes, such as healthcare systems. The determination of medical codes from an input document may trigger the performance of various computing tasks that improve the performance of a computing system (e.g., a computer itself, etc.) with respect to various actions performed by the computing system. Example actions may include the display, transmission, and/or the like of data reflective of medical code identification, such as alerts associated with a medical code that is identified for a patient, and/or the like. Moreover, the actions may include physical actions, such as an allocation of insurance coverage, mailing of a physical letter, and/or the like, that may be triggered in response to the identification of one or more medical codes.

In some examples, the computing tasks may include actions that may be based on a prediction domain. A prediction domain may include any environment in which computing systems may be applied to generate predictive insights and initiate the performance of computing tasks responsive to the predictive insights. These actions may cause real-world changes, for example, by controlling a hardware component, providing alerts, interactive actions, and/or the like. For instance, actions may include the initiation of automated instructions across and between devices, automated notifications, automated scheduling operations, automated precautionary actions, automated security actions, automated data processing actions, and/or the like.

### VI. CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. EXAMPLES

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may include a single computing entity that is configured to perform all of the steps/operations of a particular example. In addition, or alternatively, a computing system may include multiple dedicated computing entities that are respectively configured to perform one or more of the steps/operations of a particular example. By way of example, the multiple dedicated computing entities may coordinate to perform all of the steps/operations of a particular example.

Example 1. A computer-implemented method comprising: generating, by one or more processors, a plurality of overlapping data chunks from an input data object; generating, by the one or more processors and using a machine learning class-agnostic model, a plurality of intermediate feature representations respectively corresponding to the plurality of overlapping data chunks; generating, by the one or more processors and using a machine learning class-specific model, a plurality of chunk-based classification probabilities from the plurality of intermediate representations that correspond to a particular prediction class within a multi-class prediction domain; generating, by the one or more processors and using the plurality of chunk-based classification probabilities, a plurality of class scores for the plurality of overlapping data chunks with respect to the particular prediction class; and providing, by the one or more processors, a classification output that is (i) based on the plurality of class scores and (ii) comprises (a) a class prediction for the input data object and (b) an overlapping data chunk from the plurality of overlapping data chunks that corresponds to the class prediction.

Example 2. The computer-implemented method of example 1, wherein providing the class prediction and the overlapping data chunk comprises: identifying, using a max pooling function, a maximum class score from the plurality of class scores; identifying the overlapping data chunk that corresponds to the maximum class score; generating the class prediction based on a comparison between the maximum class score and a classification threshold; and providing the class prediction with the overlapping data chunk as an explanation for the class prediction.

Example 3. The computer-implemented method of any of the preceding examples, wherein the machine learning class-agnostic model comprises a pretrained encoder language model.

Example 4. The computer-implemented method of any of the preceding examples, wherein the machine learning class-specific model is one of a plurality of machine learning class-specific models within a multi-class ensemble classification model and each of the plurality of machine learning class-specific models corresponds to a different prediction class within the multi-class prediction domain.

Example 5. The computer-implemented method of example 4, wherein the classification output comprises a different prediction class prediction and corresponding overlapping data chunk for each of a plurality of prediction classes within the multi-class prediction domain.

Example 6. The computer-implemented method of any of the preceding examples, wherein the machine learning class-specific model comprises a multi-head attention model configured to: generate, using a linear layer, a hidden representation for an intermediate feature representation of the plurality of intermediate feature representations based on a particular prediction class; identify, using an activation function, a plurality of class-specific attention weights from the hidden representation; and generate a chunk-based classification probability for the intermediate feature representation based on the plurality of class-specific attention weights.

Example 7. The computer-implemented method of any of the preceding examples, wherein the machine learning class-specific model comprises a language-based attention model configured to: generate, using a machine learning feature extraction model, one or more class adjacent hidden representations for one or more adjacent class terms corresponding to the particular prediction class; generate, using a linear layer, a hidden representation for an intermediate feature representation of the plurality of intermediate feature representations based on a particular prediction class; generate one or more similarity scores between synonymous class terms and input features by merging the hidden representation with the one or more class adjacent hidden representations identify, using an activation function, a plurality of class-specific attention weights from the hidden representation; and generate a chunk-based classification probability for the intermediate feature representation based on the plurality of class-specific attention weights.

Example 8. The computer-implemented method of any of the preceding examples, wherein the overlapping data chunk comprises a text segment from the input data object that comprises at least a portion of a preceding text segment from the input data object.

Example 9. The computer-implemented method of any of the preceding examples, wherein the machine learning class-agnostic model and the machine learning class-specific model are individually pre-trained and finetuned end-to-end.

Example 10. The computer-implemented method of any of the preceding examples, wherein the machine learning class-specific model is finetuned using a semantic sentence description of class specific terms.

Example 11. A computing system comprising memory and one or more processors communicatively coupled to the memory, the one or more processors configured to: generate a plurality of overlapping data chunks from an input data object; generate, using a machine learning class-agnostic model, a plurality of intermediate feature representations respectively corresponding to the plurality of overlapping data chunks; generate, using a machine learning class-specific model, a plurality of chunk-based classification probabilities from the plurality of intermediate representations that correspond to a particular prediction class within a multi-class prediction domain; generate, using the plurality of chunk-based classification probabilities, a plurality of class scores for the plurality of overlapping data chunks with respect to the particular prediction class; and provide a classification output that is (i) based on the plurality of class scores and (ii) comprises (a) a class prediction for the input data object and (b) an overlapping data chunk from the plurality of overlapping data chunks that corresponds to the class prediction.

Example 12. The computing system of example 11, wherein providing the class prediction and the overlapping data chunk comprises: identifying, using a max pooling function, a maximum class score from the plurality of class scores; identifying the overlapping data chunk that corresponds to the maximum class score; generating the class prediction based on a comparison between the maximum class score and a classification threshold; and providing the class prediction with the overlapping data chunk as an explanation for the class prediction.

Example 13. The computing system of example 11 or 12, wherein the machine learning class-agnostic model comprises a pretrained encoder language model.

Example 14. The computing system of any of examples 11 through 13, wherein the machine learning class-specific model is one of a plurality of machine learning class-specific models within a multi-class ensemble classification model and each of the plurality of machine learning class-specific models corresponds to a different prediction class within the multi-class prediction domain.

Example 15. The computing system of example 14, wherein the classification output comprises a different prediction class prediction and corresponding overlapping data chunk for each of a plurality of prediction classes within the multi-class prediction domain.

Example 16. The computing system of any of examples 11 through 15, wherein the machine learning class-specific model comprises a multi-head attention model configured to: generate, using a linear layer, a hidden representation for an intermediate feature representation of the plurality of intermediate feature representations based on a particular prediction class; identify, using an activation function, a plurality of class-specific attention weights from the hidden representation; and generate a chunk-based classification probability for the intermediate feature representation based on the plurality of class-specific attention weights.

Example 17. The computing system of any of examples 11 through 16, wherein the machine learning class-specific model comprises a language-based attention model configured to: generate, using a machine learning feature extraction model, one or more class adjacent hidden representations for one or more adjacent class terms corresponding to the particular prediction class; generate, using a linear layer, a hidden representation for an intermediate feature representation of the plurality of intermediate feature representations based on a particular prediction class; generate one or more similarity scores between synonymous class terms and input features by merging the hidden representation with the one or more class adjacent hidden representations identify, using an activation function, a plurality of class-specific attention weights from the hidden representation; and generate a chunk-based classification probability for the intermediate feature representation based on the plurality of class-specific attention weights.

Example 18. The computing system of any of examples 11 through 17, wherein the overlapping data chunk comprises a text segment from the input data object that comprises at least a portion of a preceding text segment from the input data object.

Example 19. The computing system of any of examples 11 through 18, wherein the machine learning class-agnostic model and the machine learning class-specific model are individually pre-trained and finetuned end-to-end.

Example 20. One or more non-transitory computer-readable storage media including instructions that, when executed by one or more processors, cause the one or more processors to: generate a plurality of overlapping data chunks from an input data object; generate, using a machine learning class-agnostic model, a plurality of intermediate feature representations respectively corresponding to the plurality of overlapping data chunks;

generate, using a machine learning class-specific model, a plurality of chunk-based classification probabilities from the plurality of intermediate representations that correspond to a particular prediction class within a multi-class prediction domain; generate, using the plurality of chunk-based classification probabilities, a plurality of class scores for the plurality of overlapping data chunks with respect to the particular prediction class; and provide a classification output that is (i) based on the plurality of class scores and (ii) comprises (a) a class prediction for the input data object and (b) an overlapping data chunk from the plurality of overlapping data chunks that corresponds to the class prediction.

Example 21. The computer-implemented method of example 1, wherein the multi-class ensemble classification model comprises one or more semi-supervised machine learning classification model and the computer-implemented method further comprises receiving training data for the multi-class ensemble classification model, wherein the training data comprises one or more semantic sentence descriptions of class specific terms; and training, via one or more supervised training techniques, the multi-class ensemble classification model using the training data, wherein the one or more supervised training techniques comprise back propagation of errors and the multi-class ensemble classification model is trained to optimize a classification loss.

Example 22: The computer-implemented method of example 21, wherein the training is performed by the one or more processors.

Example 23: The computer-implemented method of example 21, wherein the one or more processors are included in a first computing entity; and the training is performed by one or more other processors included in a second computing entity.

Example 24. The computing system of example 11, wherein the multi-class ensemble classification model comprises one or more semi-supervised machine learning classification model and the one or more processors are further configured to receive training data for the multi-class ensemble classification model, wherein the training data comprises one or more semantic sentence descriptions of class specific terms; and train, via one or more supervised training techniques, the multi-class ensemble classification model using the training data, wherein the one or more supervised training techniques comprise back propagation of errors and the multi-class ensemble classification model is trained to optimize a classification loss.

Example 25: The computing system of example 24, wherein the training is performed by the one or more processors.

Example 26: The computing system of example 24, wherein the one or more processors are included in a first computing entity; and the training is performed by one or more other processors included in a second computing entity.

Example 27. The one or more non-transitory computer-readable storage media of example 20, wherein the multi-class ensemble classification model comprises one or more semi-supervised machine learning classification model and the one or more processors are further configured to receive training data for the multi-class ensemble classification model, wherein the training data comprises one or more semantic sentence descriptions of class specific terms; and train, via one or more supervised training techniques, the multi-class ensemble classification model using the training data, wherein the one or more supervised training techniques comprise back propagation of errors and the multi-class ensemble classification model is trained to optimize a classification loss.

Example 28: The one or more non-transitory computer-readable storage media of example 27, wherein the training is performed by the one or more processors.

Example 29: The one or more non-transitory computer-readable storage media of example 27, wherein the one or more processors are included in a first computing entity; and the training is performed by one or more other processors included in a second computing entity.

1. A computer-implemented method comprising:
generating, by one or more processors, a plurality of overlapping data chunks from an input data object;
generating, by the one or more processors and using a machine learning class-agnostic model, a plurality of intermediate feature representations respectively corresponding to the plurality of overlapping data chunks;
generating, by the one or more processors and using a machine learning class-specific model, a plurality of chunk-based classification probabilities from the plurality of intermediate feature representations that correspond to a particular prediction class within a multi-class prediction domain;
generating, by the one or more processors and using the plurality of chunk-based classification probabilities, a plurality of class scores for the plurality of overlapping data chunks with respect to the particular prediction class; and
providing, by the one or more processors, a classification output that is (i) based on the plurality of class scores and (ii) comprises (a) a class prediction for the input data object and (b) an overlapping data chunk from the plurality of overlapping data chunks that corresponds to the class prediction.

2. The computer-implemented method of claim 1, wherein providing the class prediction and the overlapping data chunk comprises:
identifying, using a max pooling function, a maximum class score from the plurality of class scores;
identifying the overlapping data chunk that corresponds to the maximum class score;
generating the class prediction based on a comparison between the maximum class score and a classification threshold; and
providing the class prediction with the overlapping data chunk as an explanation for the class prediction.

3. The computer-implemented method of claim 1, wherein the machine learning class-agnostic model comprises a pretrained encoder language model.

4. The computer-implemented method of claim 1, wherein the machine learning class-specific model is one of a plurality of machine learning class-specific models within a multi-class ensemble classification model and each of the plurality of machine learning class-specific models corresponds to a different prediction class within the multi-class prediction domain.

5. The computer-implemented method of claim 4, wherein the classification output comprises a different prediction class prediction and corresponding overlapping data chunk for each of a plurality of prediction classes within the multi-class prediction domain.

6. The computer-implemented method of claim 1, wherein the machine learning class-specific model comprises a multi-head attention model configured to:
generate, using a linear layer, a hidden representation for an intermediate feature representation of the plurality of intermediate feature representations based on the particular prediction class;
identify, using an activation function, a plurality of class-specific attention weights from the hidden representation; and
generate a chunk-based classification probability for the intermediate feature representation based on the plurality of class-specific attention weights.

7. The computer-implemented method of claim 1, wherein the machine learning class-specific model comprises a language-based attention model configured to:
generate, using a machine learning feature extraction model, one or more class adjacent hidden representations for one or more adjacent class terms corresponding to the particular prediction class;
generate, using a linear layer, a hidden representation for an intermediate feature representation of the plurality of intermediate feature representations based on the particular prediction class;
generate one or more similarity scores between synonymous class terms and input features by merging the hidden representation with the one or more class adjacent hidden representations;
identify, using an activation function, a plurality of class-specific attention weights from the hidden representation; and
generate a chunk-based classification probability for the intermediate feature representation based on the plurality of class-specific attention weights.

8. The computer-implemented method of claim 1, wherein the overlapping data chunk comprises a text segment from the input data object that comprises at least a portion of a preceding text segment from the input data object.

9. The computer-implemented method of claim 1, wherein the machine learning class-agnostic model and the machine learning class-specific model are individually pre-trained and finetuned end-to-end.

10. The computer-implemented method of claim 1, wherein the machine learning class-specific model is finetuned using a semantic sentence description of class specific terms.

11. A computing system comprising memory and one or more processors communicatively coupled to the memory, the one or more processors configured to:
generate a plurality of overlapping data chunks from an input data object;
generate, using a machine learning class-agnostic model, a plurality of intermediate feature representations respectively corresponding to the plurality of overlapping data chunks;
generate, using a machine learning class-specific model, a plurality of chunk-based classification probabilities from the plurality of intermediate feature representations that correspond to a particular prediction class within a multi-class prediction domain;
generate, using the plurality of chunk-based classification probabilities, a plurality of class scores for the plurality of overlapping data chunks with respect to the particular prediction class; and
provide a classification output that is (i) based on the plurality of class scores and (ii) comprises (a) a class prediction for the input data object and (b) an overlapping data chunk from the plurality of overlapping data chunks that corresponds to the class prediction.

12. The computing system of claim 11, wherein providing the class prediction and the overlapping data chunk comprises:
identifying, using a max pooling function, a maximum class score from the plurality of class scores;
identifying the overlapping data chunk that corresponds to the maximum class score;
generating the class prediction based on a comparison between the maximum class score and a classification threshold; and
providing the class prediction with the overlapping data chunk as an explanation for the class prediction.

13. The computing system of claim 11, wherein the machine learning class-agnostic model comprises a pretrained encoder language model.

14. The computing system of claim 11, wherein the machine learning class-specific model is one of a plurality of machine learning class-specific models within a multi-class ensemble classification model and each of the plurality of machine learning class-specific models corresponds to a different prediction class within the multi-class prediction domain.

15. The computing system of claim 14, wherein the classification output comprises a different prediction class prediction and corresponding overlapping data chunk for each of a plurality of prediction classes within the multi-class prediction domain.

16. The computing system of claim 11, wherein the machine learning class-specific model comprises a multi-head attention model configured to:
generate, using a linear layer, a hidden representation for an intermediate feature representation of the plurality of intermediate feature representations based on the particular prediction class;
identify, using an activation function, a plurality of class-specific attention weights from the hidden representation; and
generate a chunk-based classification probability for the intermediate feature representation based on the plurality of class-specific attention weights.

17. The computing system of claim 11, wherein the machine learning class-specific model comprises a language-based attention model configured to:
generate, using a machine learning feature extraction model, one or more class adjacent hidden representations for one or more adjacent class terms corresponding to the particular prediction class;
generate, using a linear layer, a hidden representation for an intermediate feature representation of the plurality of intermediate feature representations based on the particular prediction class;
generate one or more similarity scores between synonymous class terms and input features by merging the hidden representation with the one or more class adjacent hidden representations;
identify, using an activation function, a plurality of class-specific attention weights from the hidden representation; and
generate a chunk-based classification probability for the intermediate feature representation based on the plurality of class-specific attention weights.

18. The computing system of claim 11, wherein the overlapping data chunk comprises a text segment from the input data object that comprises at least a portion of a preceding text segment from the input data object.

19. The computing system of claim 11, wherein the machine learning class-agnostic model and the machine learning class-specific model are individually pre-trained and finetuned end-to-end.

20. One or more non-transitory computer-readable storage media including instructions that, when executed by one or more processors, cause the one or more processors to:
generate a plurality of overlapping data chunks from an input data object;
generate, using a machine learning class-agnostic model, a plurality of intermediate feature representations respectively corresponding to the plurality of overlapping data chunks;
generate, using a machine learning class-specific model, a plurality of chunk-based classification probabilities from the plurality of intermediate feature representations that correspond to a particular prediction class within a multi-class prediction domain;
generate, using the plurality of chunk-based classification probabilities, a plurality of class scores for the plurality of overlapping data chunks with respect to the particular prediction class; and
provide a classification output that is (i) based on the plurality of class scores and (ii) comprises (a) a class prediction for the input data object and (b) an overlapping data chunk from the plurality of overlapping data chunks that corresponds to the class prediction.
